(19) United States
(12) Patent Application Publication
(10) Pub. No.: US 2002/0065695 A1
(43) Pub. Date: May 30, 2002

(54) Digital chain of trust method for electronic commerce

(76) Inventors: Jacques R. Francoeur, Mountain View, CA (US); Robert J. Peizer, Mountain View, CA (US)

Correspondence Address: Jacques M. Dulin, Esq., Innovation Law Group, Ltd., Suite 101, 851 Fremont Ave., Los Altos, CA, 94024, US

(21) Appl. No.: 09/975,274

(22) Filed: Oct. 9, 2001

Related U.S. Application Data
(60) Provisional application No. 60/238,541, filed on Oct. 10, 2000.

(51) Int. Cl. G06F 17/60

(52) U.S. Cl. 705/7

(57) ABSTRACT

Architecture and method for constructing Digital Chains of Trust for e-commerce comprising integrated, universal modeling, design and evaluation framework for building DCTs for e-Business Processes that provides creation, management, and preservation of legally admissible evidence of electronic events in transactions by employing object-oriented “Trust Building Blocks” having pre-defined functions, inter-connectivity protocols, real-time feedback features, decision support options, and trust standards. It employs an end-to-end design, operation, and audit frame-work: to identify the risk drivers; to establish the necessary trust standards to acceptably mitigate each risk; to ensure the legal enforceability of electronic acts; to generate forensic evidence; and to provide audit metrics for operational compliance. It provides independently verifiable, auditable, legally admissible evidence proving the sequence and nature of electronic events of: identity (who), content (what), time-of-event (when), enforceability (how each event transpired and its compliance to legislative and industry standards), and control of access to assure privacy and confidentiality.

### CROSS REFERENCE TO RELATED APPLICATION

This application is related to and claims the benefit of the filing date under 35 USC §119 of U.S. Provisional Application Ser. No. 60/238,564 filed Oct. 7, 2000 by the same inventors under the same title.

### FIELD

The invention is directed to an architecture for, and method of, constructing a digital chain of trust for electronic commerce, and more particularly to an integrated, expert-system-based methodology and decision support system for analysis, design, implementation, operation and audit of Trusted, end-to-end, electronic Business Processes (eBPs). Trusted eBPs constructed in accord with the inventive system have legal effect and enforceability, and are in full compliance with global privacy legislation. The inventive method is constructive and evidentiary in nature, in that it provides a modeling, design and evaluation framework for building individual eBPs and larger, integrated e-commerce business systems that permits the creation, management, and preservation of legally admissible evidence of the trustworthiness of the electronic events in the eBPs. The inventive framework enables one skilled in the art to design a wide variety of eBPs with assured and measurable compliance with legislative and industry standards, and that provide legally sufficient electronic forensic evidence necessary for legal enforceability of an electronic transaction. The inventive system is universally applicable to e-commerce transactions because it is truly neutral, that it is neutral: technologically (independent of any particular type of technology or specific vendor solution); as to operational environment (Internet, Intranet, Extranet); business model independent; and geographically.

### BACKGROUND OF THE INVENTION

The critical question of e-commerce is: How can a business process be electronically implemented with integrity (i.e., be verifiably secure and authenticatable, or Trusted) at a level equivalent to physical business processes, and also be compliant with relevant legislation and industry standards and best practices? (A business process, BP, may be an individual transaction, an overall business operation, or may be an overall business model or method.)

An electronic business process that has activity components that satisfy the above characteristics is referred to as a Trusted Electronic Business Process (Trusted eBP). The underlying system of an Electronic Business Process (eBP) that addresses trust issues is referred to as its Digital Chain of Trust (DCT). Absent an adequate trust system, an eBP is not trusted, i.e., not functionally trustworthy. Customers view a non-trustworthy BP or transaction as unreliable, and shun them.

A DCT is a functional representation of the integrity, security, compliance and enforceability of the eBP, including process flows and trust assurance practices such as traceability and auditability. A basic requirement of e-commerce is to define and maintain the appropriate level of risk mitigation (Trust Standard) and to maintain that level end-to-end throughout the eBP, i.e., from beginning to close of the transaction. In another aspect, a Digital Chain of Trust is a trust system infrastructure that delivers the eBP in an end-to-end trusted condition (defined as Digital Trust) with a strong basis for legal effect and enforceability. The DCT, to be effective, must cover the entire eBP and includes all activities that affect and touch the eBP.

Together, the nature of information flowing through the eBP, the particular relevant business application, and the operational environment through which the information flows, determine the appropriate Trust Standard. For example, where the information may be personally identifiable health information the standard will be the Health Insurance Portability and Accountability Act or HIPAA, and for financial information the standard will be the Graham/Leach/Bliley Act. Other types of information that have a bearing on the structure of the DCT include, by way of example: sensitive/confidential information; personal information; proprietary business information; customer information; employee/employment information; military or national defense information; or forms of intellectual property. These different types of information are subject to various and different legal enforceability and compliance standards, thereby affecting DCT structure.

Lack of Electronic Business Process Integrity. In business-to-business (B2B) applications, the central issue is the integrity of the end-to-end electronic business process. As companies shift their business processes to the Web, they cannot be certain that their communications are private; they cannot be certain of the true identities of parties with whom they interact; they cannot be certain that information has not been altered during transmission or storage; they cannot be certain that access to confidential information will only be by those designated; and they cannot be assured that electronic agreements will not be denied or repudiated and that electronic agreements and transactions will be given the same legal effect and enforceability as paper-based commerce.

Public key infrastructure (PKI) technology, properly designed and deployed, enables limited security functions in electronic business, namely: communication privacy; information integrity; and identity authentication. However, non-repudiation and legal effect and enforceability are not enabled by PKI technology. Those are only achieved through trusted electronic business processes: those that incorporate the principles of Digital Trust; see “Digital Trust in the New Economy: The Five Principles,” Jacques Francoeur, The Handbook of eBusiness, Warren Gorham & Lamont, August 2000. PKI fully addresses neither personal information privacy nor eBP integrity.

Electronic and digital signature legislation is being enacted around the world. President Clinton signed the “Electronic Signatures in Global and National Commerce Act”, which took effect on the Oct. 1, 2000. The European Union recently enacted the “European Digital Signature Directive,” and Canada tabled on Oct. 1, 1998 the “Personal Information and Electronic Documents Act.”

Electronic signature legislation provides the basis of non-discrimination against electronic contracts and signatures, that is, paper contracts no longer have preferential treatment over e-contracts and e-signatures. This legislation furthers elimination of physical-world supply chain and business process inefficiencies, and provides a basis for legal effect and enforceability for end-to-end electronic business.

Lack of Personal Information Privacy. “The minutia of daily life—what people eat, wear, watch, ride in, play and think about—is quickly becoming one of the most sought-after commodities in the industrialized world,” see “The Data Game—How Business Invades your Privacy,” Macleans, Aug. 17, 1998. Commensurate with the enormous benefits to users of the Internet, its underlying technology (primarily software) has enabled its evolution into a massive personal information collection and exploitation machine. In fact, the lifeblood of a customer-centric business model is personal information. In the age of mass customization, where the target market is the individual, behavioral and preference information is recognized as the most valuable asset of the 21st century. However, as individuals interact on the Internet, they do not trust that their full knowledge and consent is obtained in the collection, use and disclosure of their personal information. Nor are individuals confident that the integrity of information is maintained, remains error free, that errors are easily correctable, or that their sensitive information, such as credit card numbers, is secure.

Conflicting trends of consumer information exploitation and consumer mistrust have produced a privacy revolution around the world. No fewer than 40 countries already have or are enacting privacy legislation governing the collection, use and disclosure of personally identifiable information in the private sector, “Privacy and Human Rights, An International Survey of Privacy Laws and Developments,” Global Internet Liberty Campaign, October 1988. Such legislation will require businesses to fundamentally change how they use employee, business and consumer personal information in the new economy. The impact: virtually every company and organization will need to implement changes to their personal information management practices: specifically how they collect, use and disclose the information.

The domains of personal information privacy and security traditionally have been separate. Both domains are increasingly central to trusted business operations, and the requirements for both have a substantial and growing common basis of solution: hence the need for and utility of an integrated trust approach.

For example, the Personal Information Privacy (PIP) requirement of access control is satisfied by the security feature of Identity Authentication (Digital Certificates); the confidentiality requirement of PIP is satisfied by encryption; and the non-repudiation aspect of security is satisfied in part by the process control and traceability requirements of PIP. The requirements under electronic signature legislation of Disclosure, Notice and Consent are also principles of PIP.

Inefficient and Ineffective Industry Approach To Resolving the Problems. The industry approach to resolving the trust infrastructure issues of, security, business process integrity, legal effect and enforceability personal information privacy compliance have the following inefficiencies:

Lack of a strong basis for legal enforceability; that the audit trail has verifiable integrity; and that the architecture itself has demonstrable integrity

A non-integrated privacy/security implementation approach. Two domains (personal information privacy, security) are considered distinct, and operate mutually exclusively;

Fragmented focus on providing a segment of the overall solution—individual “Trust Segments”—not an end-to-end solution;

Focus is on technology interoperability, not Trust Interoperability, across multiple solution types and vendors;

No mechanism to define and normalize the Trust Standard across multiple vendors of same trust solution, such as a Digital Certificate (a DC);

No mechanism to define and normalize the Trust Standard of the various trust solutions that must be connected for end-to-end business process integrity;

Lack of end-to-end systems approach to electronic business process design;

Lack of integrated cross-disciplinary consideration (technological, legislative, contractual);

Lack of incorporating trust infrastructure by design in eBP (post-deployment re-engineering). A company will design its eBP, and then attempt to integrate a specific vendor's trust solution(s). This leads to sub-optimal trust infrastructure designs and increased trust, business process integration, and scalability issues.

Accordingly, there is an urgent need for a methodology for designing a trustworthy architecture for electronic business processes involved in e-commerce that overcomes these serious problems and the fragmented industry approach in response thereto, and that provides a solution that is universal and neutral as to technology, operating environment, business application, and geography.

### THE INVENTION

### Summary, Including Objects and Advantages

The inventive architecture for and method of constructing a digital chain of trust for electronic commerce comprises an integrated, expert-system-based methodology and decision support system for analysis, design, implementation, operation and audit of Trusted, end-to-end electronic, Business Processes (eBPs). Trusted eBPs constructed in accord with the inventive system have legal effect and enforceability, and are in full compliance with global privacy legislation. The inventive method is constructive and evidentiary in nature, in that it provides a modeling, design and evaluation framework for building individual eBPs and larger, integrated e-commerce business systems that permits the creation, management, and preservation of legally admissible evidence of the trustworthiness of the electronic events in the eBPs. The inventive framework enables one skilled in the art to design a wide variety of eBPs with assured and measurable compliance with legislative and industry standards, and that provide legally sufficient electronic forensic evidence necessary for legal enforceability of an electronic transaction. The inventive system is universally applicable to e-commerce transactions because it is truly neutral, that it is neutral: technologically (independent of any particular type of technology or specific vendor solution); as to operational environment (Internet, Intranet, Extranet); business model independent; and geographically.

The inventive method for designing a DCT system for a particular eBP is based on object-oriented “Trust Building Blocks” that embody pre-defined functions, interconnectivity protocols, real-time feedback features, decision support options, trust standards and other properties and information.

The inventive DCT system architecture employs a systematic and analytical, end-to-end design, operation, and audit framework: to identify the risk drivers; to establish the necessary trust standards to mitigate each risk independently to an acceptable level commensurate with the due diligence requirements of the particular application; to ensure the legal enforceability of electronic acts; to generate the legally required electronic forensic evidence; and to provide audit metrics to ensure operational compliance. The system ensures there is independently verifiable electronic evidence, to a forensic level of certainty that has been defined as a requirement of legislative and industry standards (and which will change over time), which evidence is legally sufficient to prove the sequence and nature of electronic events specifically related to identity (who), content (what), time-of-event (when), enforceability (how each event transpired and its demonstrated compliance to legislative and industry standards), and personal information privacy. The evidence generated by the inventive system also proves that there was sufficient control of access to the electronic information at each step in the eBP to assure privacy and confidentiality. Such independently verifiable forensic evidence generated by the inventive system is essential for audits and a posteriori analyses required as the basis for legal enforcement and adjudication of electronic business processes and practices.

Table 1 next below provides definitions of trust building blocks and related terms used throughout this application:

TABLE 1.1
PROPRIETARY DEFINITIONS

| Term | Acronym | Definition |
|---|---|---|
| Digital Chain of Trust | DCT | a representation of the integrity, security, compliance and en- |
| | | forceability functionality of the eBP; including process flows |
| | | and trust assurance practices such as traceability and |
| | | auditability. |
| Risk Category | RC | The universal and irreducible 6 key areas of risk in an |
| | | electronic event: Identity Risk (who), Information Integrity |
| | | Risk (what), Time-of-event Risk, (when), Enforceability Risk |
| | | (how), Confidentiality Risk (access), and Privacy Risk. |
| Digital Trust | DT | A state in which the eBP embodies assured and measurable |
| | | integrity, security, compliance, and enforceability, resulting |
| | | from each of the 6 risk categories being mitigated consistently |
| | | and end-to-end to its specified level, through its corresponding |
| | | DCT. |
| Trust Standard | TS | Defines the specific “acceptable level” of risk mitigation at the |
| | | highest functional level in an electronic process, usually based |
| | | on the nature of both the information and the business |
| | | application, the operating environment (Internet, Intranet, |
| | | Extranet, etc.), and on legislative and industry standards. |
| Trust Building Block | TBB | The first logical functional subdivision of any Trust Segment |
| | | essential to mitigate the 6 risk categories that arise in |
| | | conducting e-commerce. |
| Trust Segment | Tseg | Any of the six subsystems of the DCT (Trusted Identity |
| | | Authentication, Trusted Information Integrity, Trusted Time, |
| | | Trusted Digital Receipt, Trusted Access, Personal Information |
| | | Privacy) that map directly against, and whose purpose is to |
| | | mitigate to an “acceptable level” the 6 key risk categories: |
| | | Identity Risk (who), Information Integrity Risk (what), Time- |
| | | of-event Risk, (when), Enforceability Risk (how), Confiden- |
| | | tiality Risk (access), and Privacy Risk. |
| Trust Requirement | TR | Defines level of integrity (degree of assurance) required of |
| | | functions that provide regulatory compliance to standards such |
| | | as those specified in European Union Directive 1999/93/Ec |
| | | On A Community Framework For Electronic Signatures. |
| Trust Element | TE | Performs a single function (e.g., encryption/decryption or |
| | | hashing), to a specific level of integrity defined by an input |
| | | parameter such as key length. Trust Elements are technology |
| | | oriented, and are the purview of highly specialized industry |
| | | experts. |
| Trust Level | TL | The resultant degree of integrity of a function when it |
| | | performs to a given input parameter: for example, resistance to |
| | | encryption varies directly by key length. |
| Object-Oriented | OOTE | Any part of the DCT, irrespective of where it is sectioned, |
| | | with predefined relationship hierarchies, predefined collective |
| | | functions, interconnectivity protocols, real-time feedback fea- |
| | | tures, decision support options, and other properties and infor- |
| | | mation; that acts as a single entity with those characteristics: |
| | | contains information or functional behavior that defines the |
| | | nature of the interactions with other entities on the DCT. |
| Trust Component | TC | One or more Trust Elements linked together form Trust Com- |
| | | ponents that are designed to fulfill a specific Trust Require- |
| | | ment, e.g, secure electronic signature creation, secure elec- |
| | | tronic signature verification, established by regulatory stand- |
| | | ards such as those specified in the European Directive. Trust |
| | | Requirements are the purview of regulatory, legislative, and |
| | | standards bodies. |
| Trust Integrity | TI | The maintenance of the same level of assurance between the |
| | | various subsystems of the DCT, down to the most granular |
| | | level and between sections of the subsystem. |
| Trust Parameter | TP | Variable such as key length, algorithm type, that determines the |
| | | strength of the mitigation technique |
| Trust Practices | TPr | Organizational and technological policies and procedures that |
| | | ensure, through defined metrics and internal/external audits, |
| | | that the company policies and procedures are being |
| | | implemented and maintained properly. This ensures that |
| | | management assertions to its stakeholders are authentic and |
| | | thereby controlling risk and liability to the predetermined |
| | | accentable level. |

TABLE 1.2
INDUSTRY DEFINITIONS

| | | |
|---|---|---|
| Electronic Signature Data | ESD | Data in electronic form that are attached to or logically |
| | | associated with an electronic record and that serve as a method |
| | | of authentication |
| Signatory | SY | A person who holds a signature creation device and acts either |
| | | on his own behalf or on behalf the natural or legal person he |
| | | represents |
| Signature Verification Code | SVC | the result of a record processed through a hashing algorithm, |
| | | known as a Message Digest. |

The inventive method and system for construction of a trusted DCT is a tool for analysis and design of a wide variety of eBPs for legislative compliance, business process integrity, and legal effect and enforceability. The inventive DCT construction method is used both to transform physical business processes into trusted web-based electronic equivalents, and to design, analyze and re-engineer existing electronic business processes. The inventive methodology is based on an integrated trust approach. This methodology integrates both disciplines of PIP and security to design end-to-end electronic business process integrity; enabled by digital signature legislation and in compliance with global privacy legislation.

The inventive system automatically factors in technological, legislative and contractual issues and offers options and templates through a decision support function in designing and deploying Trusted End-to-End eBPs. The resulting eBP DCT produced in accord with the invention thus meets the requirements for end-to-end electronic business process integrity, including satisfying all regulatory and legal proof standards for:

communication privacy (confidentiality);

information integrity;

identity authentication, access control;

traceability;

auditability;

risk management, mitigation & control;

liability management & control;

non-repudiation;

legal effect and enforceability;

privacy legislation compliance; and

financial institutional requirements

Although non-repudiation is traditionally considered an independent benefit of PKI, as communication privacy is derived from, not a direct intent of, encryption, information integrity (digital signatures) and identity authentication (digital certificates), in fact non-repudiation is not a benefit of PKI. It is a benefit dependent on many factors outside of PKI, such as (but not limited to) auditability, due diligence, industry best practices, policies and procedures, enforcement and legislation. It is dependent on the integrity of the end-to-end electronic business process. In contrast, the inventive DCT construction methodology is designed to ensure that the eBP is enforceable in a court of law by generating electronic transaction process flow sheets and/or diagrams that demonstrate the integrity of eBP design, and by providing documentation (traceability —an exact log of events) as electronic forensic evidence. This evidence generated by the inventive system as implemented in a particular eBP is auditable by an independent third party.

The inventive DCT construction methodology permits the design of the business and functional needs of the eBP in parallel, simultaneous with building the trust infrastructure requirements, and independent of any particular type of technology or specific vendor solution. Once the eBP and trust infrastructure designs are complete, the inventive DCT construction system provides a library of vendor-specific object-oriented Trust Building Blocks that can be mapped into the model DCT to arrive at an operational design. In so doing, the inventive DCT construction system automatically generates trust specifications to which vendors are required to conform.

In another aspect of the inventive DCT construction system methodology, it can generate screens of the complex DCT in multiple user-defined perspectives, including, but not limited to:

| | |
|---|---|
| 1. Trust Chain Representation-B: | Business perspective |
| 2. Trust Chain Representation-F: | Functional perspective |
| 3. Trust Chain Representation-T: | Technical perspective |
| 4. Trust Chain Representation-L: | Legal perspective |
| 5. Trust Chain Representation-P: | Privacy perspective |
| 6. Trust Chain Representation-S: | Security perspective |
| 7. Trust Chain Representation-A: | Audit perspective |

In each of the perspectives described above, the executive or planner in each respective area of responsibility would see a view or screen of the DCT configured specifically for that area of responsibility. By way of example, in the Trust Chain Representation—B: Business perspective, the CEO would view the business perspective for insight as to the implications of the DCT on the business model; in Trust Chain Representation—L: Legal or legislative perspective, the general counsel or attorney for the firm would view the legal implications or consequences to the firm of the DCT; in Trust Chain Representation—A: Audit perspective, the compliance officer would view the compliance implications of the model, and so on.

Another important aspect of the invention is its embodiment as an Internet-based business method. In this method aspect, the delivery of services of constructing a truly verifiable DCT to user customers, in which a service or consulting organization employs the inventive methodology, templates and architecture for developing a verifiable DCT applicable to a specific customer eBP or transaction is via a website accessed over the Internet. In this embodiment of the invention, the services of design, implementation and management of a customer's specialized, dedicated DCT is preferably enabled via an Internet-based business system and management programs therefor, and more particularly to customized DCT construction and management through an Internet site offering to customers a full suite of DCT management, educational and analytic tools, reports, accounting, record production and archiving, certification and metrics. In this embodiment, the inventive DCT services hosting site offers verifiable DCT advisory services to its members and customers, and to visitors, who access the services offered through the site via the Internet using various user-accessed computer devices, such as laptops, desktop computers, PDAs, handheld computers, phones and pagers, network computers and the like, over land lines, satellites or wireless connections.

This Internet business method aspect of the invention also includes a full computer system for management of site operations, communications, database operations, results analysis and reporting, processing, member, observer and subscriber relations, membership and subscriber base creation and billing. Examples include DCT analysis programs that monitor the needs of a particular eBP or transaction, performance of the individual customer's DCT on a transaction by transaction basis, archives the electronic evidence as it is created for audit purposes, prepares certificates and verification of transaction integrity documentation, interfaces with a messaging program to provide messages to and from the users/customers, and the like. The hosting site facilitates trust service professionals to design, generate, implement and manage DCTs of a plurality of customers, and provides analytic tools that facilitate the analysis of the eBP, transaction and DCT operations, and further provides communication tools to generate, transmit and receive, archive, search, order (arrange, sort, rank, etc.) and retrieve relevant information to multiple users, including information personalized for particular, customized DCTs, eBPs or transactions. Income to the Site entity is generated through subscription, service and membership revenues, publications and reports revenue, operation of broker/vendor services, click-through fees and commission sharing with outside vendors of sub-services or programs, and the like.

The processes underlying the site operation, communications between site visitors, members customers, vendors and trust services professionals, and underlying the Internet-implemented business method as described herein may be implemented in software as computer-executable instructions that upon execution perform the operations illustrated in the several figures and described herein. The Web server(s) of the DCT service site may be implemented as one or more computers configured with server software to host a site on the Internet, and that implement the serving of static, generally informational Web pages, creates, updates and permits access to subscriber and vendor links, and that generates and serves dynamic Web pages tailored to facilitate the delivery of the services and methodology described herein, including serving dynamic pages tailored to individual users that may be generated on the fly in response to individual requests from the users via their Internet linked access devices (computers, PDAs, cell phones, pagers, etc.).

The computer(s) of the invention can be configured in a system architecture, for example, as one or more server computer(s), database computer(s), routers, interfaces and peripheral input and output devices, that together implement the system and network. A computer used in the inventive system typically includes at least one processor and memory coupled to a bus. The bus may be any one or more of any suitable bus structures, including a memory bus or memory controller, peripheral bus, and a processor or local bus using any of a variety of bus architectures and protocols. The memory typically includes volatile memory (e.g., RAM) and fixed and/or removable non-volatile memory (e.g., ROM, Flash, hard disk including in RAID arrays, floppy disc, mini-drive, Zip, Memory stick, PCMCIA card, tape, optical (CD-ROM, etc.), DVD, magneto-optical, and the like), to provide for storage of information, including computer-readable instructions, data structures, program modules, operating systems, and other data used by the computer(s). A network interface is coupled to the bus to provide an interface to the data communication network (LAN, WAN, and/or Internet) for exchange of data among the various site computers, routers, and investor computing devices. The system also includes at least one peripheral interface coupled to the bus to provide communication with individual peripheral devices, such as keyboards, keypads, touch pads, mouse devices, trackballs, scanners, printers, speakers, microphones, memory media readers, writing tablets, cameras, modems, network cards, RF, fiber-optic and IR transceivers, and the like.

A variety of program modules can be stored in the memory, including OS, server system programs, HSM (Hierarchical Storage Management) system programs, application programs, other programs modules and data. In a networked environment, the program modules may be distributed among several computing devices coupled to the network, and used as needed. When a program is executed, the program is at least partially loaded into the computer memory, and contain instructions for implementing the operational, computational, archival, sorting, screening, classification, formatting, rendering, printing and communication functions and processes described herein.

The user, member, customer, service professional, instrument or transaction, personal, trust element, company, etc., data are stored in one or more sets of data records, which can be configured as a relational database (hierarchical network, or other type database) in which data records are organized in tables, which records may be selectively associated with one another pursuant to predetermined and selectable relationships, so that, for example, data records in one table are correlated to corresponding records for the user, transaction, verification step, etc. in another table and the correlation or individual datum is callable for rendering on screen, printout or other activity pursuant to the inventive method and system. The hosting site facilitates the DCT need analysis for a particular eBP, the design of a suitable verifiable DCT, the implementation, the training on use of the DCT system, the management of the system, the archiving of relevant records, and the like, and provides both: analytic tools that facilitate the analysis of the performance of the methodology and architecture for construction of a customized DCT, its performance in eBPs or particular transactions: and communication tools to generate, transmit and receive, archive, search, order (arrange, sort, rank, etc.), retrieve and render DCT operational information to multiple customers and users.

### BRIEF DESCRIPTION OF THE DRAWINGS

The invention is described in more detail by reference to the relational schematic drawings, in which:

FIG. i shows the inventive trusted, end-to-end electronic business digital chain of trust model;

FIG. ii shows the digital chain of trust relational hierarchy legends that applies to all figures;

FIG. 1.0 shows trust building blocks of trust segment 1, trust identity authentication;

FIG. 1.1 shows trust components of trust building block 1.1, identity registration;

FIG. 1.1.1 shows the trust functions of trust component 1.1.1, identity vetting process of trust building block 1.1, identity registration of trust segment 1, trusted identity authentication;

FIG. 1.2 shows the trust components of trust building block 1.2, identity certification life cycle, of trust segment 1, trusted identity authentication;

FIG. 1.3 shows the trust components of trust building block 1.3, identity certification verification of trust segment 1, trust identity authentication;

FIG. 1.4 shows the trust components of trust building block 1.4, signature creation data life cycle of trust segment 1, trust identity authentication;

FIG. 2.0 shows the trust building blocks of trust segment 2, trusted information integrity;

FIG. 2.1 shows the trust components of trust building block 2.1, digital fingerprint;

FIG. 2.2 shows the trust components of trust building block 2.2, electronic signature creation of trust segment 2, trusted information integrity;

FIG. 2.3 shows the trust components of trust building block 2.3, electronic signature verification of trust segment 2, trusted information integrity;

FIG. 3.0 shows the trust building blocks of trust segment 3, trusted time;

FIG. 3.1 shows the trust components of trust building block 3.1, legal time source;

FIG. 3.2 shows the trust components of trust building block 3.2, time synchronization;

FIG. 3.3 shows the trust components of trust building block 3.3, time stamping;

FIG. 4 shows the trust building blocks of trust segment 4, trusted digital receipts;

FIG. 5 shows the trust building blocks of trust segment 5, trusted access;

FIG. 5.1 shows the trust components of trust building block 5.1, transmission and reception of electronic record;

FIG. 5.1.2 shows trust elements of trust component 5.1.2, record encryption of trust building block 5.1, transmission and reception of electronic record, of trust segment 5, trusted access;

FIG. 5.2 shows the trust components of trust building block 5.2, storage of electronic record;

FIG. 5.3 shows the trust components of trust building block 5.3, archival of electronic record;

FIG. 5.4 shows the trust components of trust building block 5.4, electronic record retrieval and verification;

FIG. 6 shows the trust building blocks of trust segment 6, personal information privacy; and

FIG. 7 shows an exemplary business process employing a DCT constructed in accord with the invention, involving a financial transaction between a customer (signatory) and an institution (relying party).

### DETAILED DESCRIPTION, INCLUDING THE BEST MODES OF CARRYING OUT THE INVENTION

The following detailed description illustrates the invention by way of example, not by way of limitation of the principles of the invention. This description will clearly enable one skilled in the art to make and use the invention, and describes several embodiments, adaptations, variations, alternatives and uses of the invention, including what is presently believed to be the best modes of carrying out the invention.

In this regard, the invention is illustrated in the several figures, and is of sufficient complexity that the many parts, interrelationships, and sub-combinations thereof simply cannot be fully illustrated in a single patent-type drawing. For clarity and conciseness, several of the drawings show in schematic, or omit, parts of the system architecture or steps of the DCT construction methods that are not essential in that drawing to a description of a particular feature, aspect or principle of the invention being disclosed. Thus, the best mode embodiment of one feature may be shown in one drawing, and the best mode of another feature will be called out in another drawing.

All publications, patents and applications cited in this specification are herein incorporated by reference as if each individual publication, patent or application had been expressly stated to be incorporated by reference.

After the DCT is designed, the inventive DCT construction system methodology employs object-oriented client-side software modules in conjunction with web-based access that provide the framework of analysis and design, and a “Bill of Trusted Materials” is generated whereby an evolving database of pre-certified vendor-specific solutions incorporating relevant Trust Building Blocks such as Trust Elements and Trust Components is accessed to complete the construction of the operational DCT. The designer selects the appropriate Trust Building Blocks by clicking on the vendor link for each requirement, and has further access to linked resources including but not limited to:

up-to-date information, including legislation and emerging technology;

trust interoperability contract templates, Personal Information Privacy data transfer contracts;

checklists and guidelines, examples of policies and procedures;

information on new vendor solutions;

access to a library of pre-certified “trustworthy” object-oriented, vendor-supplied trust building blocks with pre-defined functions, interconnectivity protocols, real time feedback features, trust standards and other properties and information;

automated compatibility analysis between trust requirements and solutions;

automated decision support functions;

design modelling, including testing and iterative optimisation;

comprehensive identification, analysis and management of all aspects of the Digital Chain of Trust: Errors & Omissions mitigation (human error, corporate memory);

interoperability issues addressed by intrinsic nature of object oriented trust building blocks (Trust Segment, Trust Component, Trust Element), each containing specific attributes, functions, and properties, governing interactions;

virtual design & modelling tools permit analysis of impact of design decisions on the eBP prior to final design and deployment;

performance modelling: modelling of design choices on eBP performance (speed, response and bandwidth bottlenecks, scalability, availability);

provides up-to-date information resources, such as legislation, trust model examples

lowest Total Cost of Solution (single outsourced solution amortized over many clients results in low relative cost compared with internal solution);

generates “trust operating rules” (community participants must comply with these rules) based on business model and defined Trust Standard;

A Trust Lexicon, providing a structured and systematic framework of analysis; the basis for discussion and assessment of an eBP, definition of its Trust Standard, and design of its DCT;

Set forth below is a discussion of each of the object-oriented building blocks of the DCT construction methodology in accord with the invention. In accord with the inventive architectural template for construction of a trusted DCT, the DCT to be developed for a particular eBP is composed of a series of object-oriented Trust Building Blocks (TBB). A TBB is any combination or configuration of Trust Segments, Trust Components and Trust Elements that have a predefined relationship hierarchy and predefined functions, interconnectivity protocols, real-time feedback features, decision support options, and other properties and information.

The following is a detailed description of the functional and relational hierarchy of the Digital Chain of Trust Methodology, including the constituent Trust Segment (TS), Trust Building Blocks (TBB), Trust Component (TC), and Trust Element (TE). This description illustrates the inventive architecture or template, as it were, for design of end-to-end electronic business process integrity by the systematic application of risk mitigation from the most basic level (function) to the highest level (system), yielding the state of Digital Trust. It also illustrates the inductive reasoning behind the methodology.

Trust Element. A Trust Element performs a function (such as encryption, decryption, hashing) to a specific Trust Level (e.g., Low: 48-bit encryption=breakable; High: 1024-bit encryption=unbreakable) as determined by the input parameters (encryption key length, algorithm type). Trust Elements are characteristic of technology and are the purview of highly specialized technical experts.

Trust Elements perform Trust Functions that can vary in Trust Level, while producing the same characteristic result. For example, encryption is a Trust Function that, depending on the key length and algorithm type, will produce varying levels of resistance to decryption. It is important to realize that the degree of integrity (level of trust, degree of risk mitigation) of the overall DCT is determined, in part, by the lowest level of the chain or Trust Element. A degree of trust higher than those established by the Trust Elements cannot be achieved—hence the concept that the chain is only as strong as its weakest link.

Trust Component. A Trust Component is comprised of one or more Trust Elements linked together to fulfill a specific Trust Requirement (e.g., secure electronic signature creation, secure electronic signature verification), established by legislative and regulatory standards such as those specified in the European Union “Directive 1999/93/EC Of The European Parliament And Of The Council Of The Dec. 13th 1999 On A Community Framework For Electronic Signatures.” Trust Components are characteristic of regulatory requirements and are the purview of regulatory, legislative and standards bodies.

Trust Components execute sub-processes that can vary in Trust Requirement, while producing the same characteristic result. For example the Trust Component (TC: 1.1.1) Identity Vetting can be performed by using three distinct vetting processes, delivering the same characteristic result (Identity Vetting) but with varying degrees of Trust Requirement: Physical Vetting (high trust requirement), Behavioral Profile Vetting (medium trust requirement) and Consistency and Accuracy Vetting (low trust requirement).

Trust Building Block. Trust Building Blocks are comprised of at least two Trust Components, and are the first logical subdivision of the processes essential to each Trust Segment to mitigate the corresponding risk category. Trust Building Blocks are characteristic of the overall risk sensitivity of the company and are the purview of business executives. For example, how a company sources time (Trust Segment 2—Trusted Time) for its network and synchronizes its time-driven devices is a decision affected by outside forces, but ultimately is made on the basis of the risks the company is willing to take, as enacted by the executives.

Trust Segment. Any of the six subsystems of the DCT (Trusted Identity Authentication, Trusted Information Integrity, Trusted Time, Trusted Digital Receipt, Trusted Access, and Personal Information Privacy) that map directly against, and the purpose of which is to mitigate to an “acceptable level,” the 6 key risk categories: Identity Risk (who), Information Integrity Risk (what), Time-of-event Risk, (when), Enforceability Risk (how), Confidentiality Risk (access), and Privacy Risk. A given Trust Segment is comprised of at least two Trust Building Blocks.

Digital Chain of Trust. A representation of the integrity, security, compliance and enforceability functionality of the eBP, including process flows and trust assurance practices such as traceability and auditability.

The following table demonstrates the concept of end-to-end electronic business process integrity by a method involving a systematic application of risk mitigation from the most basic level (function) to the highest level (system) yielding the state of Digital Trust. This is a state in which the eBP embodies assured and measurable integrity, security, compliance, and enforceability, resulting from each of the 6 risk categories being mitigated consistently and end-to-end to its predetermined level, through the corresponding Trust Segments of the DCT. Thus, Trust Integrity is the consistent application of the same level of integrity, specifically same Trust Level between linked Trust Elements, the same Trust Requirement between linked Trust Components and the same Trust Standards between linked Trust Building Blocks.

TABLE 2
eBP Integrity

| | | |
|---|---|---|
| Trust Element | Trust Level | Trust functions to a specific level of integrity |
| Trust Component | Trust Requirement | Compliance (regulatory, industry best practices) |
| Trust Building Block | Trust Standard | Risk sub-processes mitigated to specific level |
| Trust Segment | Category Risks | Risk categories mitigated to acceptable level |
| Digital Chain of Trust | Operational Risk | Integrity, security, compliance & enforceability |
| | | risk mitigation |

The following exemplary description of the relational hierarchy between the six Trust Segments (TS) of the Digital Chain of Trust in accord with this invention and the TS constituent components: Trust Building Blocks (TBB), Trust Components (TC) and Trust Elements (TE), is best shown in a hierarchical list format to facilitate clarity. The Digital Chain of Trust is intrinsically non-linear or fractal in nature. The DCT does not necessarily follow a linear progression from higher order links to lower-level links. For example: Trust Segments are composed of Trust Building Blocks, which are in turn composed of Trust components, that are in turn composed of Trust Elements that perform Trust Functions to a specified Trust Level. A higher order chain may link to a lower order chain depending on the trust functionality that must be satisfied at any given point along the functional process of the business. The underlined lines in the list indicate this fractal nature. Recipient, Signatory, Relying Party and Data Subject should all be considered equally, and can be used interchangeably, as representing an individual in a particular business context all having their identities attested in an Identity Certificate or alternate mechanism.

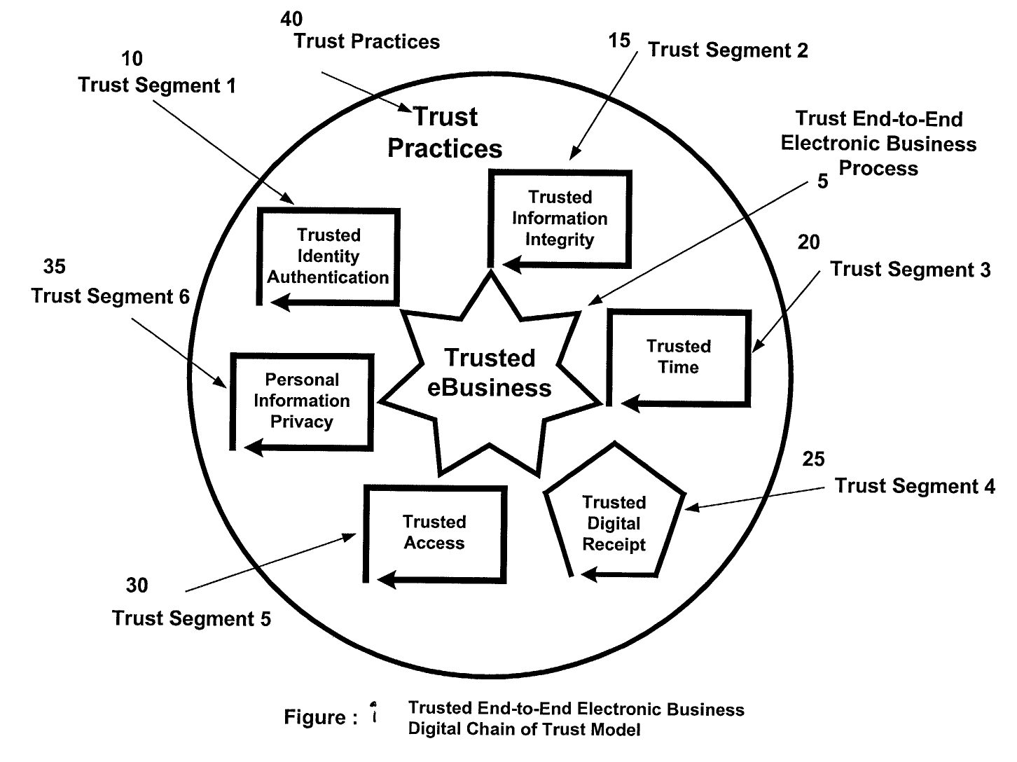

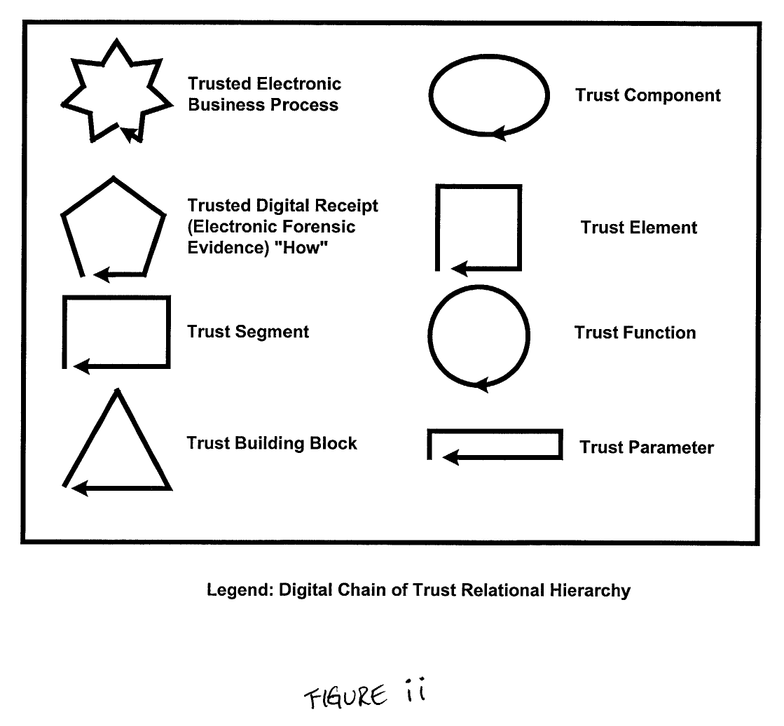

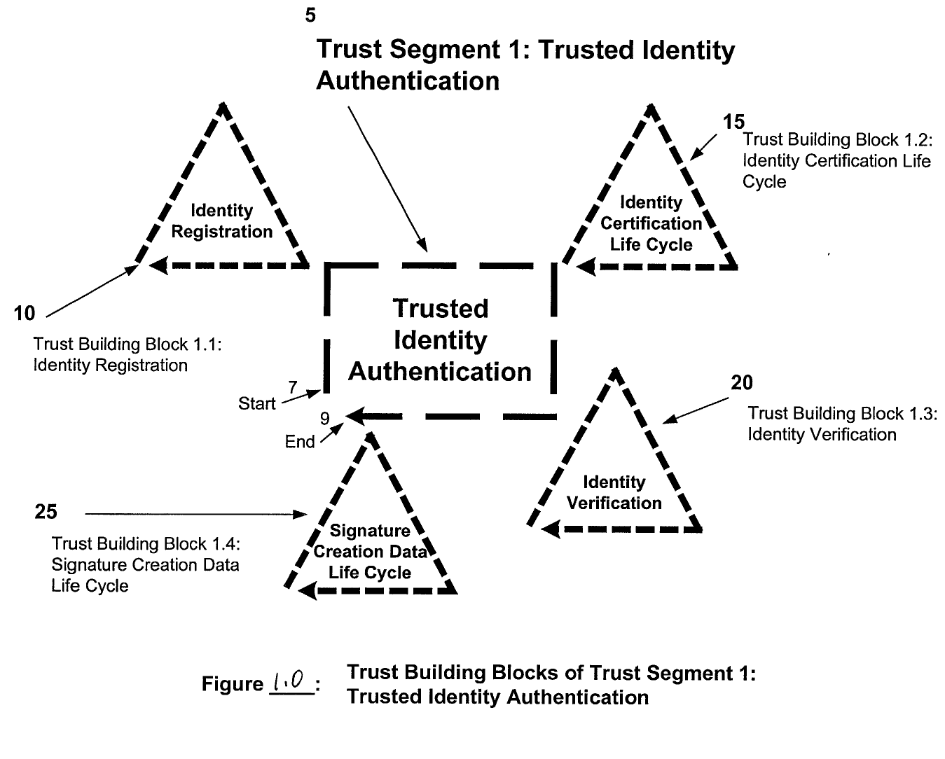

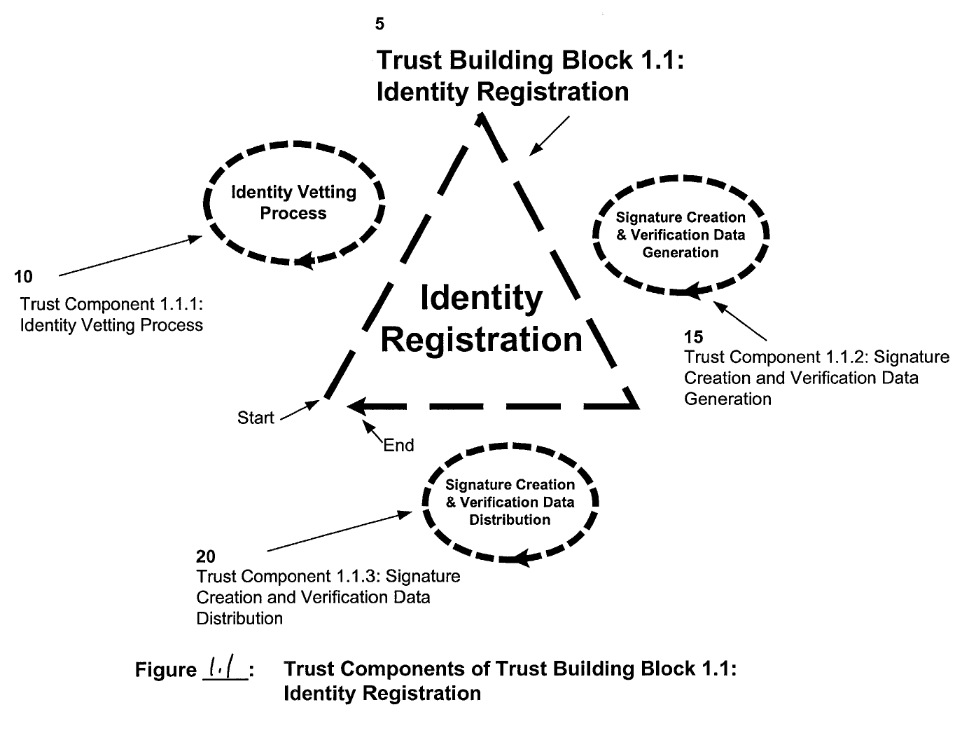

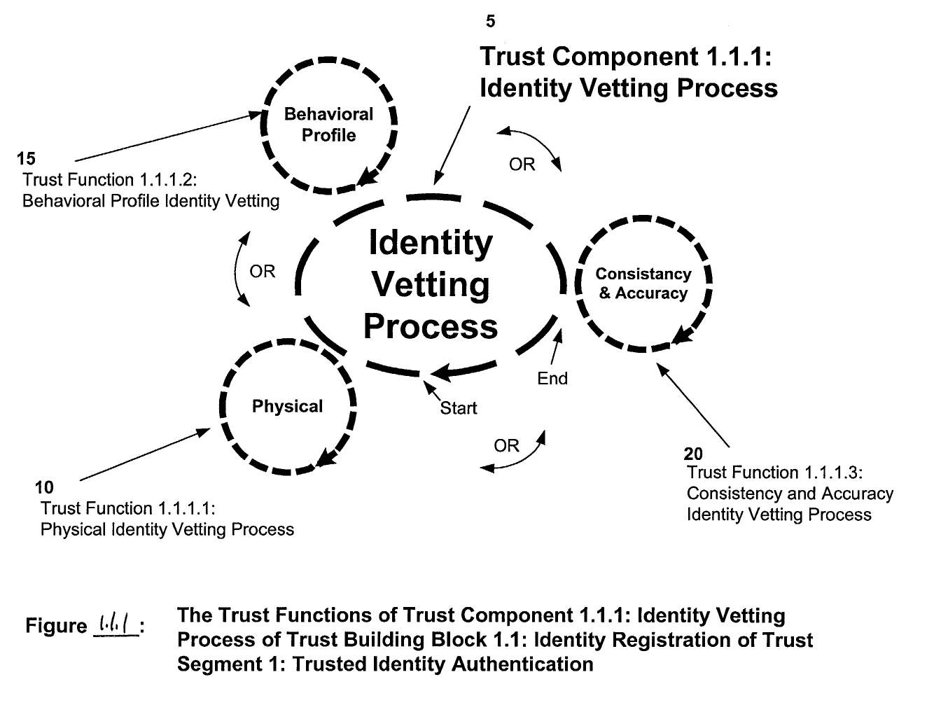

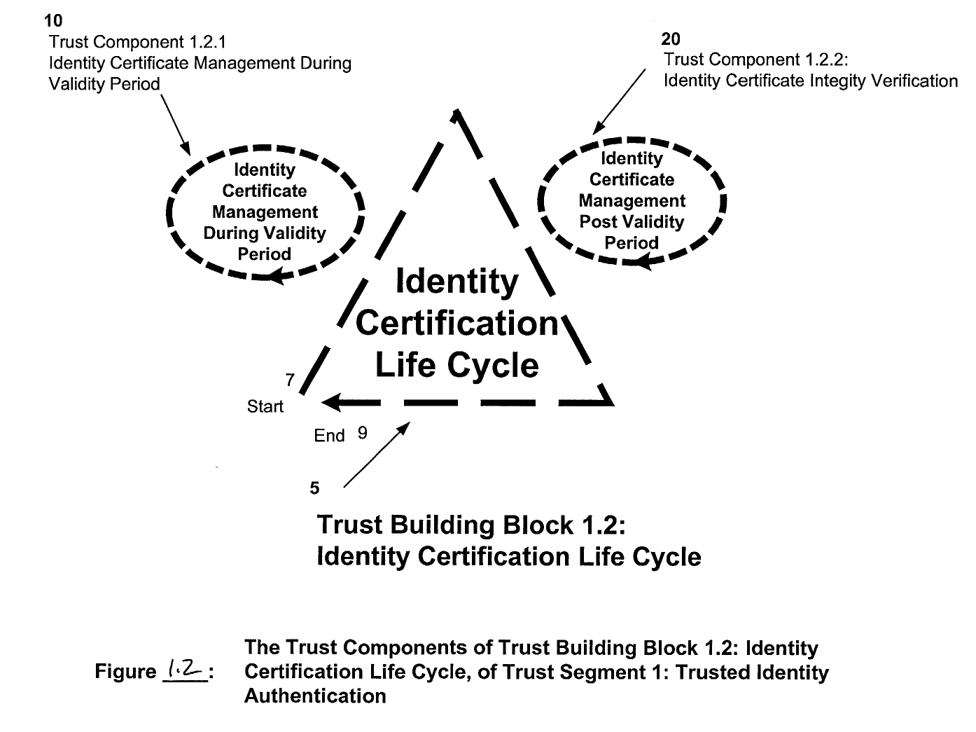

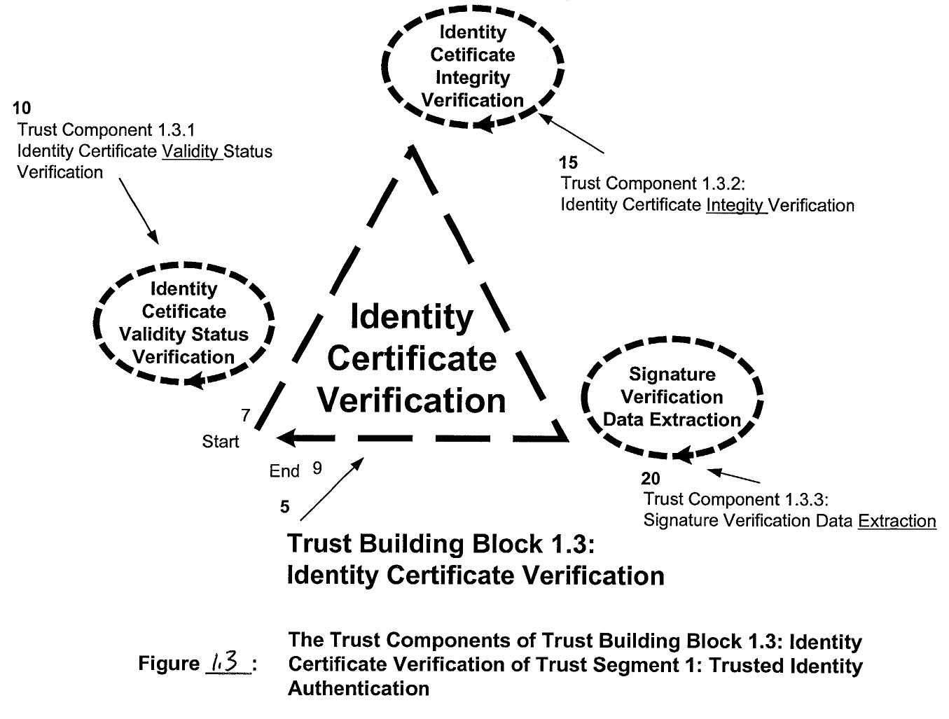

1. TS: Trusted Identity Authentication (Who), refer to FIG. 1.0

1.1. TBB: Identity Registration, described below with reference to FIG. 1.1

1.1.1. TC: Identity Vetting Process, as described next below with reference to FIG. 1.1.1

1.1.1.1. TF: Physical Identity Vetting, or

1.1.1.2. TF: Behavioral Profile Identity Vetting, or

1.1.1.3. TF: Consistency & Accuracy Identity Vetting

1.1.2. TC: Signature Creation Data (SCD) and Signature Verification Data (SVD) Generation

1.1.2.1. TE: Generate SCD and SVD and ensure: uniqueness, confidentiality and one cannot be derived from knowledge of the other

1.1.3. TC: Signature Creation Data (SCD) and Signature Verification Data (SVD) Distribution

1.1.3.1. TE: Binding of Signature Verification Data to Identity Certificate

1.1.3.2. TE: Secure and Confidential delivery of Signature Creation Data to Individual

1.2. TBB: Identity Certification Life Cycle, refer to FIG. 1.2

1.2.1. TC: Identity Certificate Management During Validity Period

1.2.1.1. TE: Issue Identity Certificate

1.2.1.2. TE: Directory and Public Access of Identity Certificate

1.2.1.3. TE: Real Time Identity Certificate Status Verification (Relying Party Verification

1.2.1.4. TE: Real Time Identity Certificate Revocation or Suspension

1.2.2. TC: Identity Certificate Management During Post Validity Period,

1.2.2.1. TE: Identity Certificate Storage

1.2.2.2. TE: Identity Certificate Archival

1.3. TBB: Identity Certificate Verification, refer to FIG. 1.3

1.3.1. TC: Identity Certificate Validity Status Verification

1.3.1.1. TE: Request Identity Certificate Status from Certification Service Provider

1.3.1.2. TE: Correctly Display Results of Status Verification

1.3.2. TC: Identity Certificate Integrity Verification

1.3.2.1. TE: Perform Content Integrity Verification (Similar to TC: 2.3.2 but in the case of the Identity Certificate Electronic Signature)

1.3.2.2. TE: Correctly Display Results of Integrity Verification

1.3.3. TC: Signature Verification Data Extraction

1.4. TBB: Signature Creation Data Life Cycle, refer to FIG. 1.4

1.4.1. TC: Signature Creation Data Storage

1.4.1.1. TE: Signature Creation Generation in Secure Storage Device

1.4.1.2. TE: Signature Creation Generation secure transfer to a Secure Storage Device

1.4.2. TC: Signature Creation Data Control (prevention from unauthorized access and execution)

1.4.3. TC: Signature Creation Data Access

1.4.3.1. TE: Unique Access Procedures (uniquely linked only to the Signatory)

1.4.3.2. TE: Confidential Access Procedures (only known by the Signatory)

1.4.4. TC: Signature Creation Data Execution (Electronic Signature Creation)

1.4.5. TC: Signature Creation Data Post Validity Period Storage and Archival

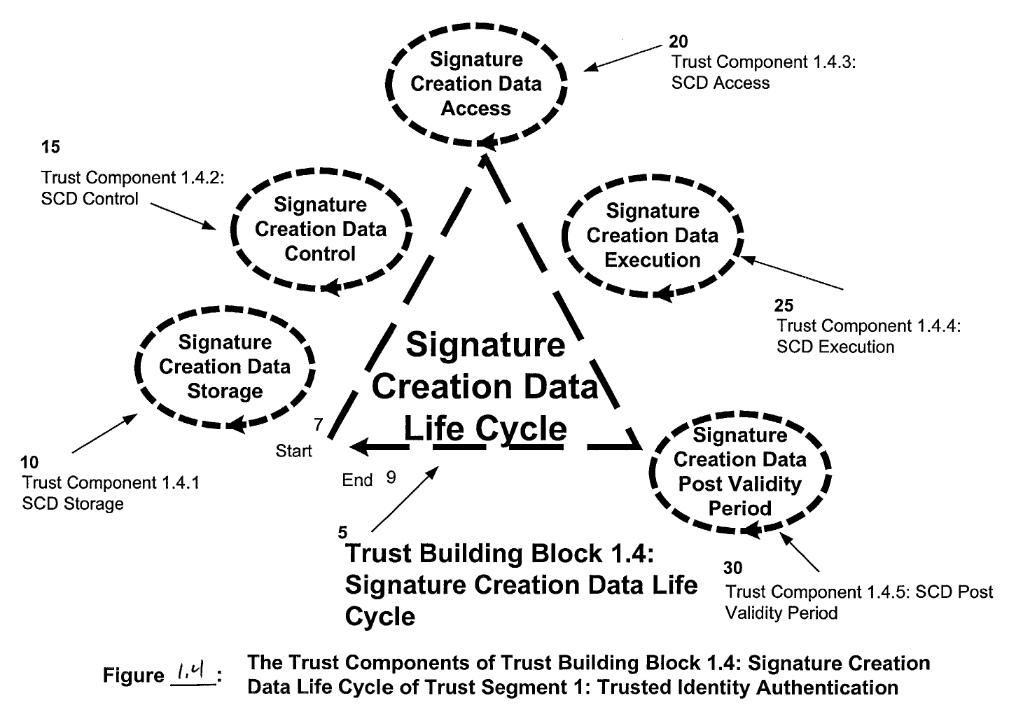

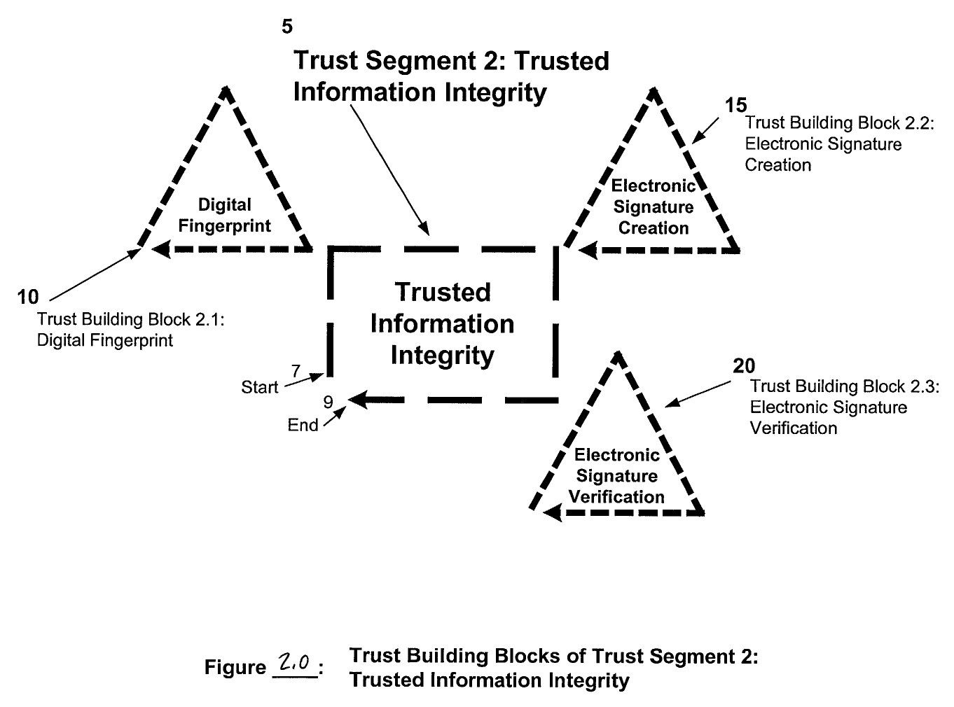

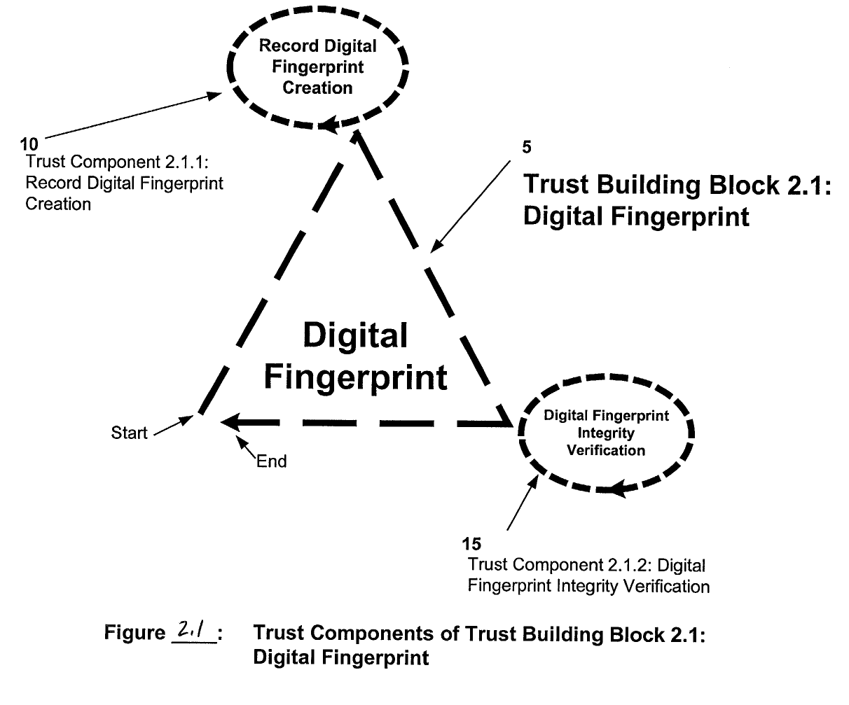

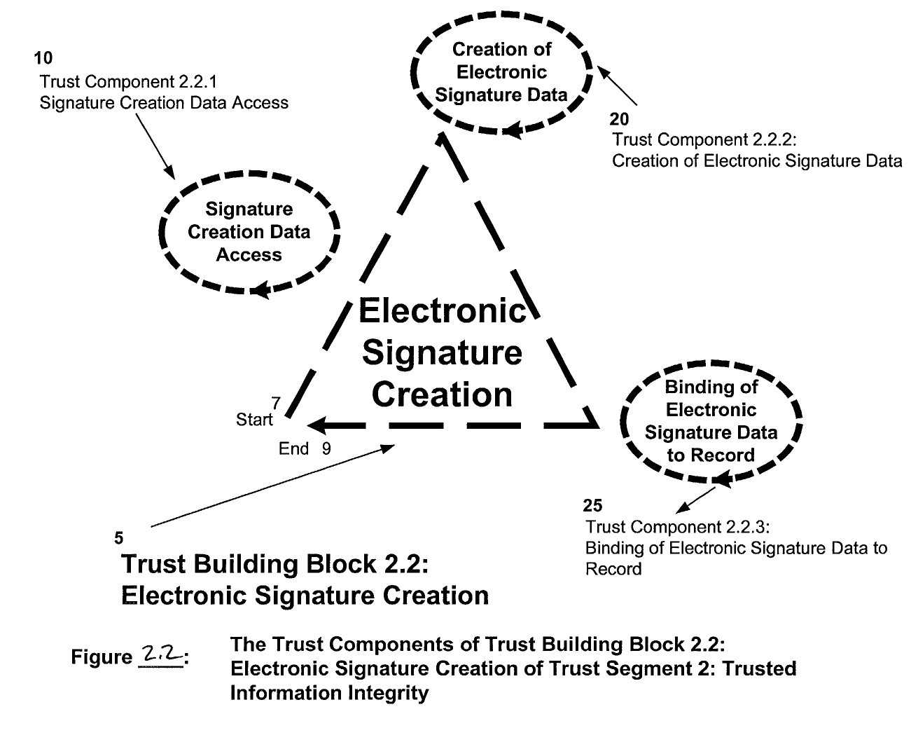

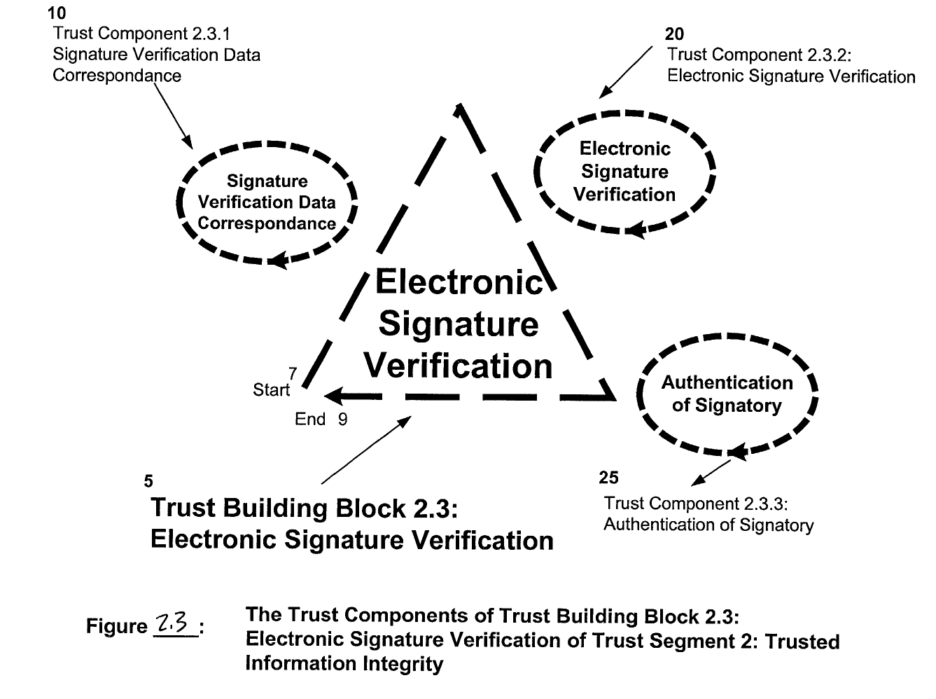

2. TS: Trusted Information Integrity (What), refer to FIG. 2.0

2.1. TBB: Digital Fingerprint, refer to FIG. 2.1

2.1.1. TC: Record Digital Fingerprint Creation

2.1.1.1. TE: Generate Record Verification Code (message digest) of Original Record

2.1.2. TC: Digital Fingerprint Integrity Verification

2.1.2.1. TE: Create New Record Verification Code

2.1.2.2. TE: Record Verification Codes Comparison (New to Original Message Digest)

2.1.2.3. TE: Display Result of Verification to Verifier

2.1.2.4. TE: Display correctly the Content of the plain text Record

2.2. TBB: Electronic Signature Creation, refer to FIG. 2.2

2.2.1. TC 1.3.3: Signature Creation Data Access

2.2.2. TC 1.3.4: Creation of Electronic Signature Data (i.e., Signature Creation Data Execution)

2.2.2.1. TE: TBB 2.1.1: Record Digital Fingerprint Creation

2.2.2.2. TE: Binding of Signature Creation Data to Digital Fingerprint (e.g. encryption by Private Key)

2.2.3. TC: Binding of Electronic Signature Data to Record

2.2.3.1. TE: Access Original Record

2.2.3.2. TE: Generate link to, or association of, Electronic Signature Data to Original Record

2.3. TBB: Electronic Signature Verification, refer to FIG. 2.3

2.3.1. TC: Signature Verification Data Correspondence Validation (to the Signatory of the Record)

2.3.2. TC: Electronic Signature Verification

2.3.2.1. TE: Decrypt Electronic Signature Data (with Signature Verification Data to yield Original Message Digest)

2.3.2.2. TE: go to TC 2.1.2: Digital Fingerprint Integrity Verification

2.3.3. TC: Authentication of Signatory

2.3.3.1. TE: go to TBB 1.3 Identity Authentication

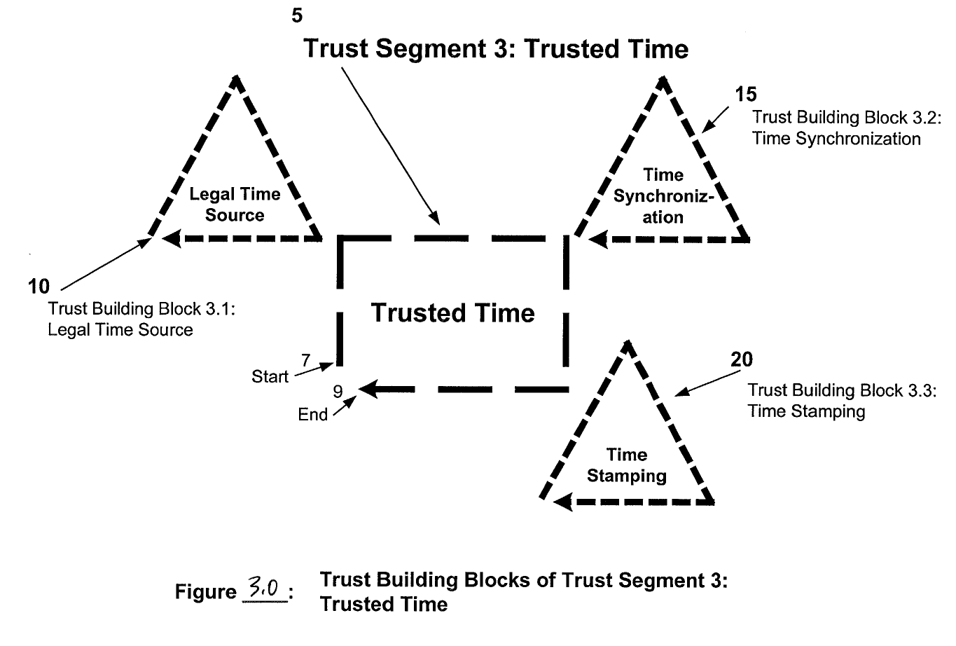

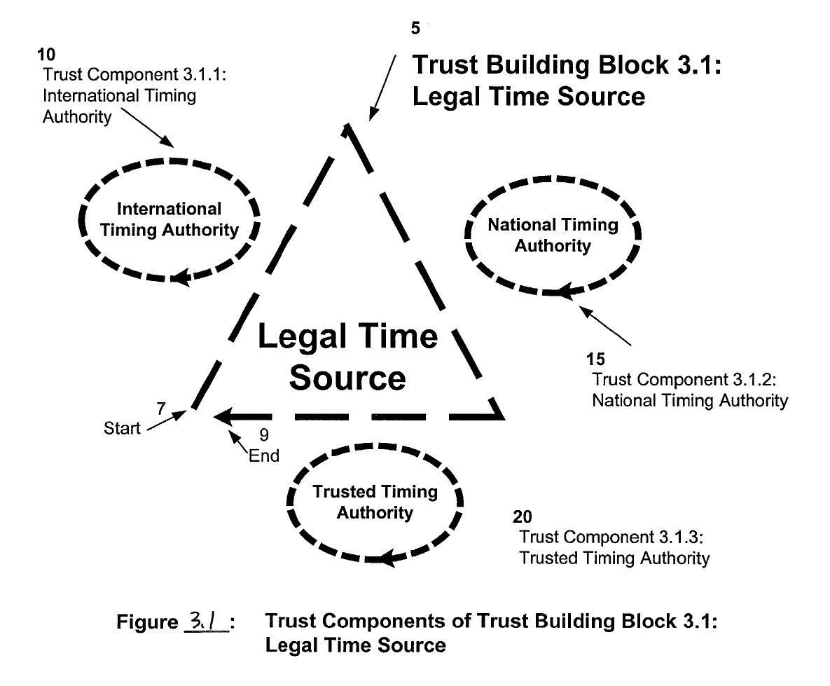

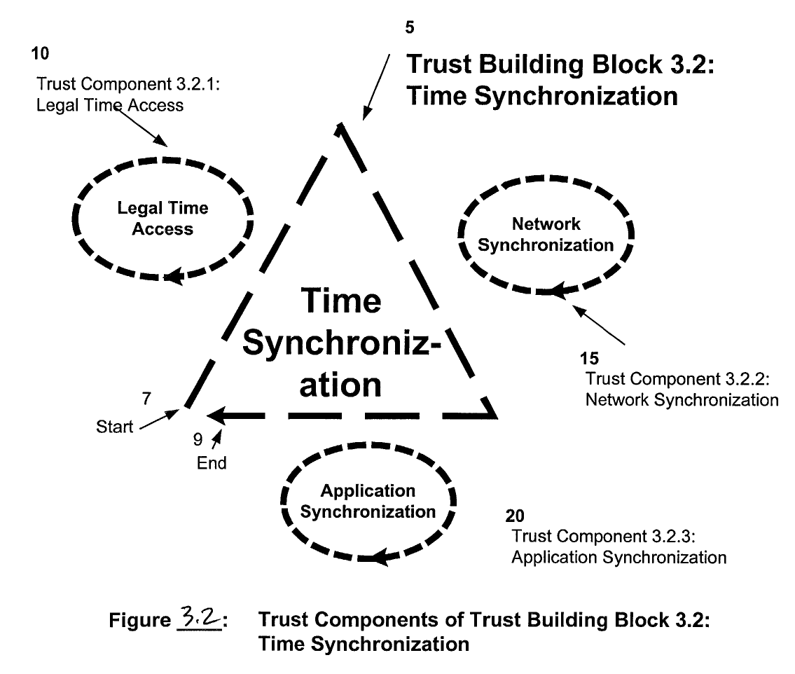

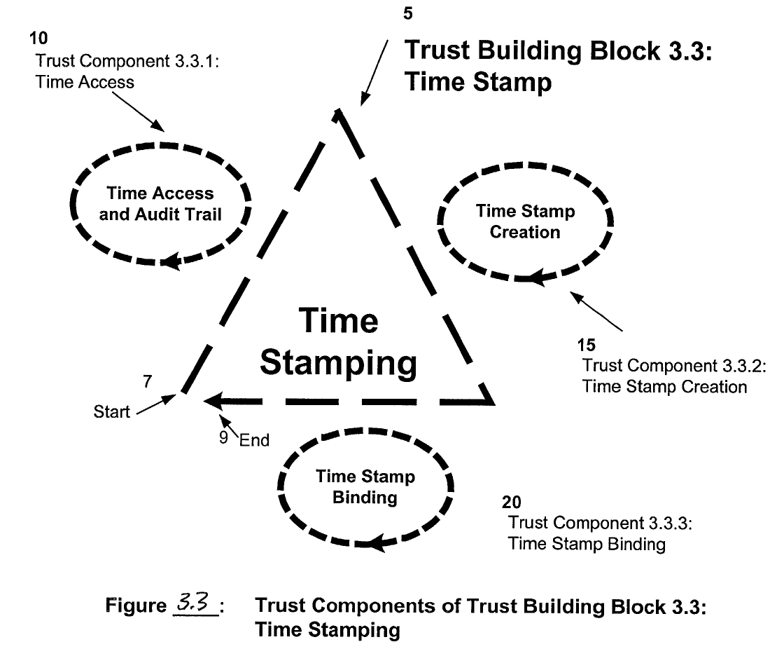

3. TS: Trusted Time (When), refer to FIG. 3.0

3.1. TBB: Legal Time Source, refer to FIG. 3.1

3.1.1. TC: International Timing Authority (access to Universal Coordinated Time)

3.1.2. TC: National Timing Authority, or

3.1.3. TC: Trusted Timing Authority

3.2. TBB: Time Synchronization, refer to FIG. 3.2

3.2.1. TC: Legal Time Access

3.2.2. TC: Network Synchronization

3.2.3. TC: Application Synchronization

3.3. TBB: Time Stamping, refer to FIG. 3.3

3.3.1. TC: Time Access and Audit Trail

3.3.2. TC: Time Stamp Creation

3.3.2.1. TE: Record containing time information and audit trial to legal time source

3.3.2.2. TE: Time Record Digital Fingerprint Creation: go to TC 2.1.1 Digital Fingerprint Creation of Record

3.3.2.3. TE: Create Time Stamp Electronic Signature Data (encrypt Digital Fingerprint using system Signature Creation Data)

3.3.3. TC: Time Stamp Binding: go to TC 2.2.3 Binding of Electronic Signature Data to Original Record (Link Time Record Electronic Signature to Record)

4. TS: Trusted Digital Receipts (How), refer to FIG. 4.0

4.1. TBB: Identity Electronic Forensic Evidence: go to TS1: Trusted Identity Authentication

4.2. TBB: Record Electronic Forensic Evidence: go to TS2: Trusted Information Integrity

4.3. TBB: Time Electronic Forensic Evidence: go to TS3: Trusted Time Audit

4.4. TBB: Digital Receipt Storage and Archival: go to TBB 5.2: Storage of Electronic Record, and TBB 5.3: Archival of Electronic Record

4.5. TBB: Digital Receipt Retrieval and Verification: go to TBB 5.2: Storage of Electronic Record, and TBB 5.4: Retrieval and Verification of Electronic Record

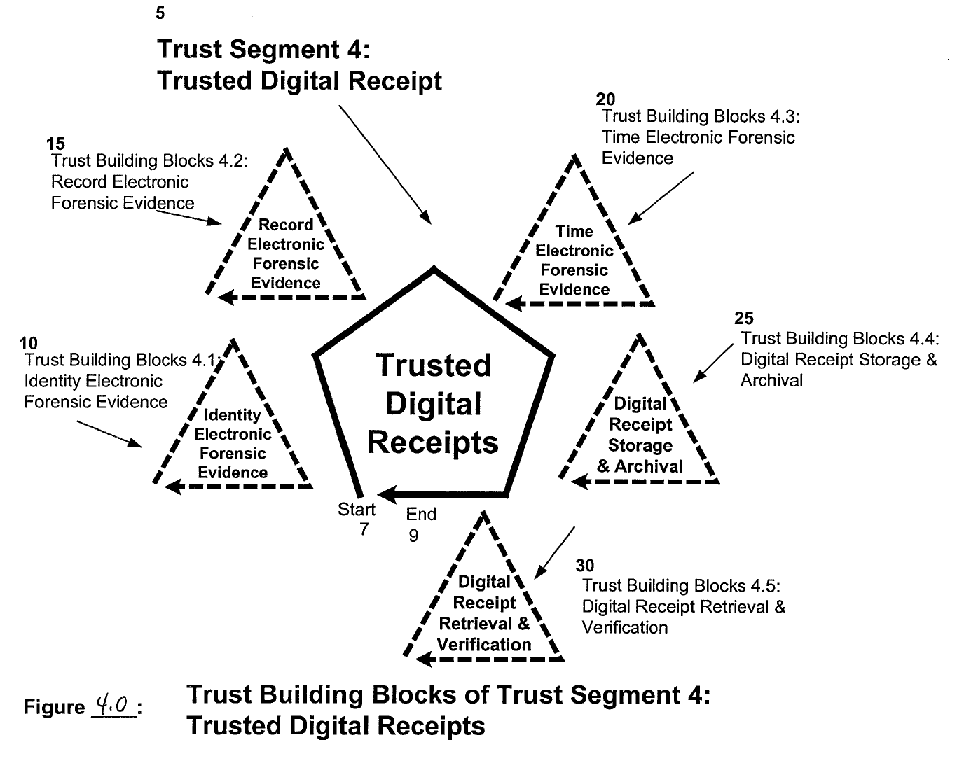

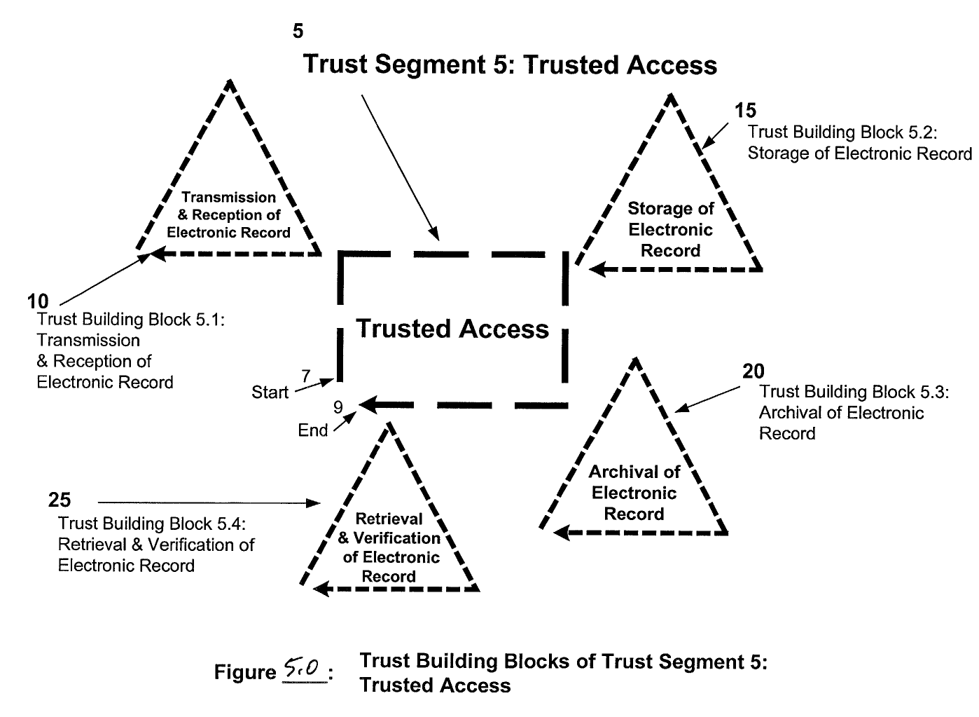

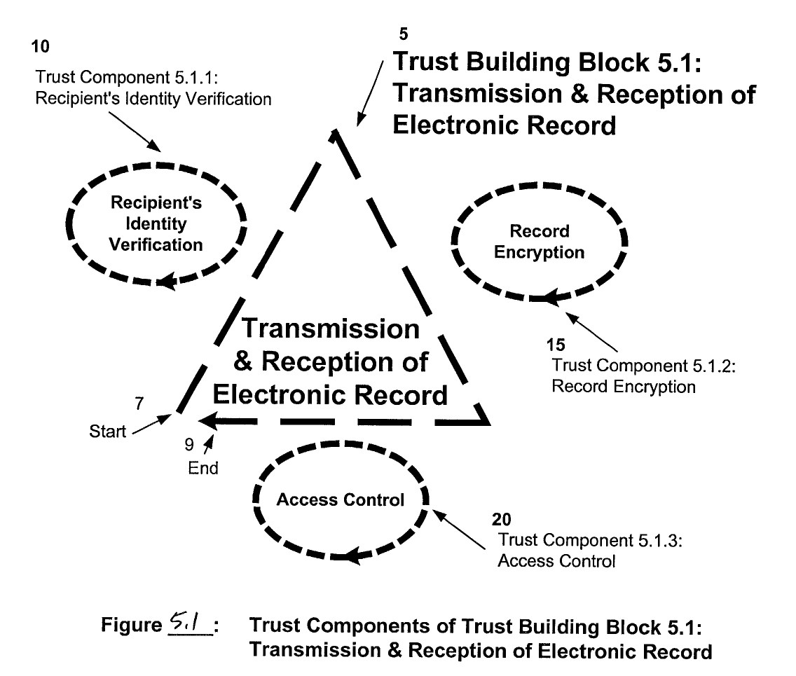

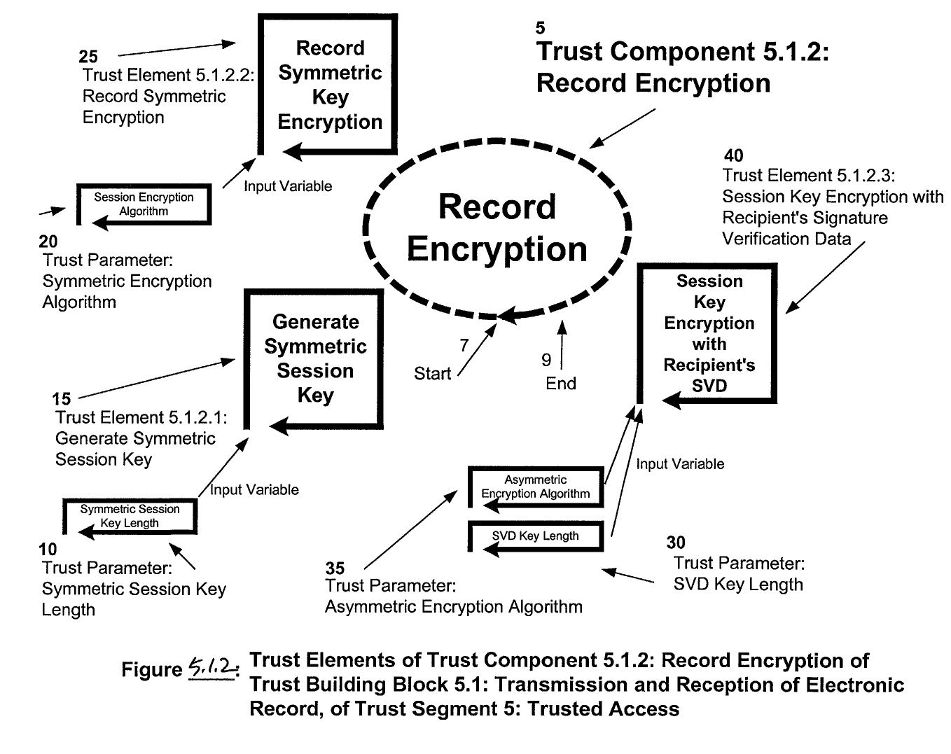

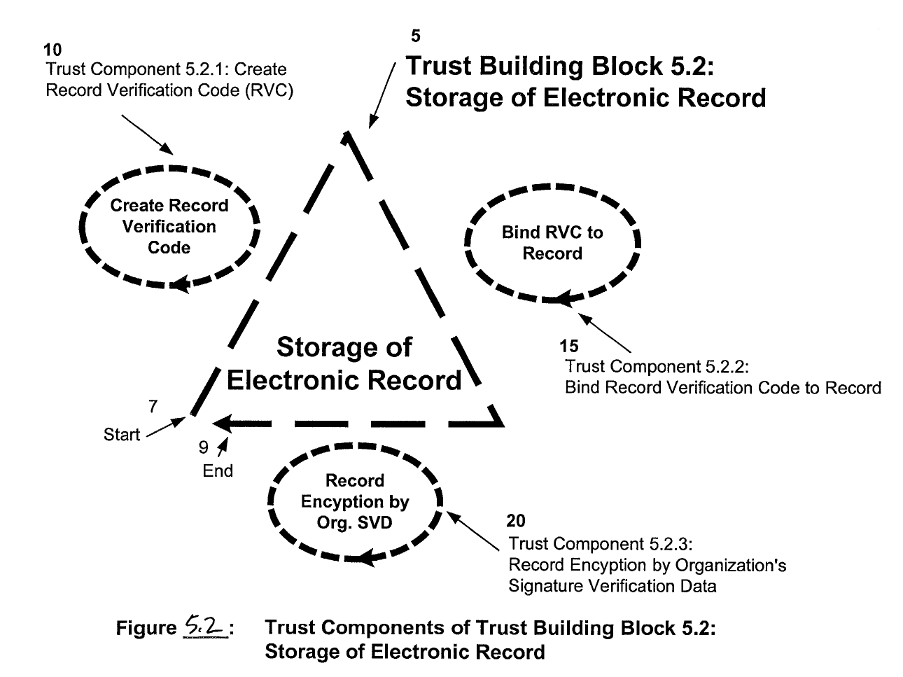

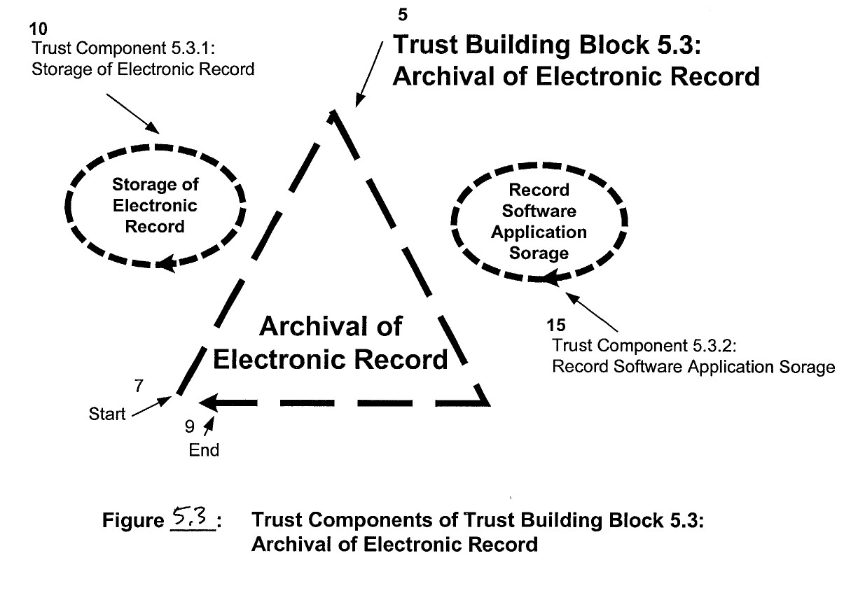

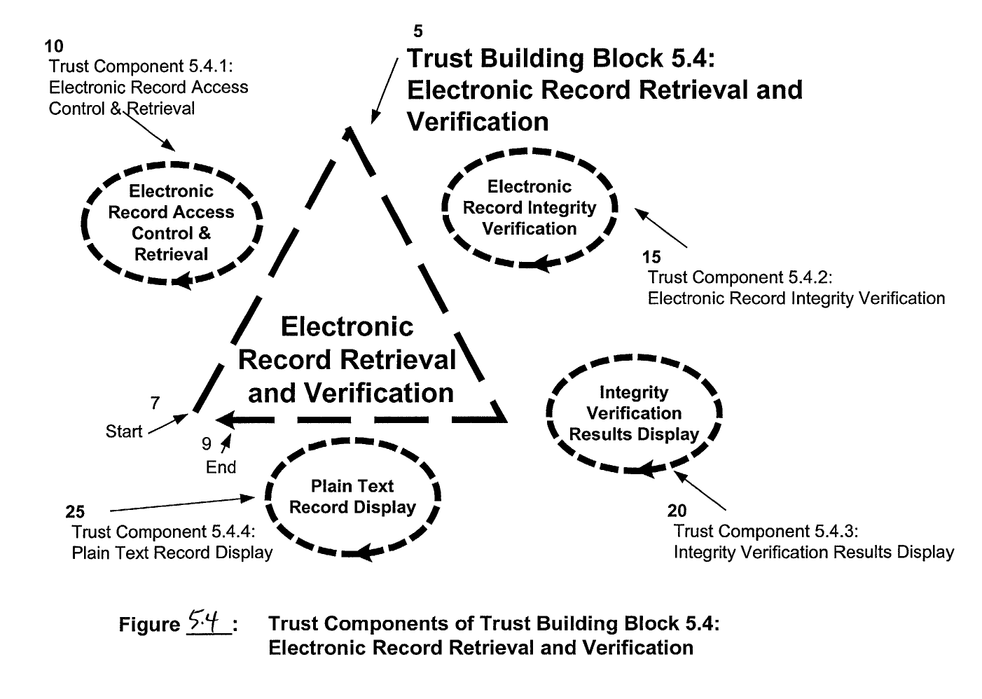

5. TS: Trusted Access (Security), refer to FIG. 5.0

5.1. TBB: Transmission and Reception of Electronic Record, refer to FIG. 5.1

5.1.1. TC: Recipient(s) Identity Verification: go to TBB 1.3: Identity Certificate Verification

5.1.2. TC: Record Encryption, refer to FIG. 5.1.2

5.1.2.1. TE: Generate Symmetric Session Key

5.1.2.2. TE: Record Symmetric Session Key Encryption

5.1.2.3. TE: Session Key Encryption with Recipient(s) Signature Verification Data

5.1.3. TC: Access Control

5.1.3.1. TE: Recipient(s) Signature Creation Data Access

5.1.3.2. TE: Session Key Decryption with Recipient(s) Signature Creation Data

5.1.3.3. TE: Record Decryption

5.2. TBB: Storage of Electronic Record, refer to FIG. 5.2

5.2.1. TC: Create Record Verification Code (message digest)

5.2.2. TC: Bind Record Verification Code to Original Record

5.2.3. TC: Record Encryption by organizational Signature Verification Data, refer to FIG. 5.2.3

5.3. TBB: Archival of Electronic Record, refer to FIG. 5.3

5.3.1. TC: Storage of Electronic Record

5.3.2. TC: Record Software Application Storage

5.4. TBB: Retrieval and Verification of Electronic Record, refer to FIG. 5.4

5.4.1. TC: Electronic Record Access Control and Retrieval

5.4.2. TC: Electronic Record Integrity Verification

5.4.3. TC: Integrity Verification Results Display

5.4.4. TC: Plain Text Record Display

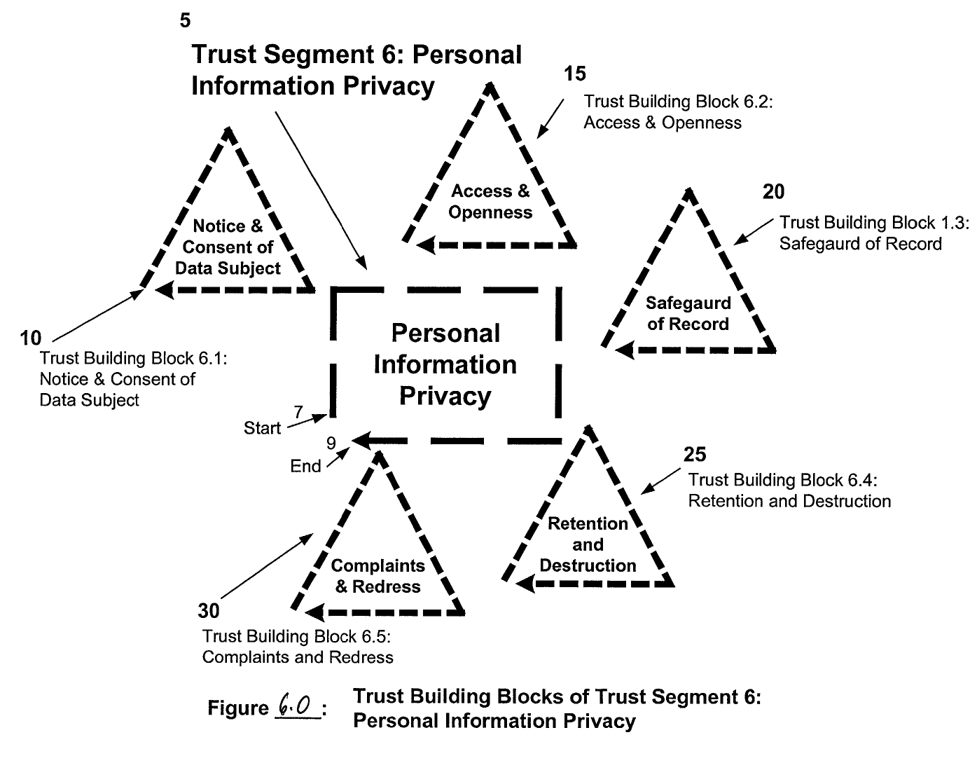

6. TS: Personal Information Privacy (Privacy), refer to FIG. 6.0

6.1. TBB: Notice and Consent of Data Subject (or Signatory), refer to FIG. 6.1

6.1.1. TC: Purpose of Record Processing

6.1.2. TC: Disclosure of Record to Third Parties

6.1.3. TC: Rights of Data Subject

6.1.4. TC: Presumed, Implicit, or Explicit Consent

6.2. TBB: Access and Openness, refer to FIG. 6.2

6.2.1. TC: Openness of Company Policies and Practices

6.2.2. TC: Access to Record for Accuracy, Completeness and Correction

6.2.3. TC: Relevance of Personal Data

6.3. TBB: Safeguard of Record, refer to FIG. 6.3

6.3.1. TC: Access Control to Record

6.3.2. TC: Access and Alteration Traceability of Record

6.3.3. TC: Integrity of Record: go to TBB 2.1 Information Integrity

6.4. TBB: Retention and Destruction of Record, per established company policy

6.5. TBB: Complaints and Redress, per established company policy

The Methodology allows the user to select any part of the DCT and to define (create) a dynamic TBB. The Methodology automatically generates the TBB's new object-oriented trust functionality (predefined functions, interconnectivity protocols, real-time feedback features, decision support options, and other properties and information). The user is also able to edit the dynamic TBB, whereupon the DCT Methodology regenerates the TBB's new object-oriented trust functionality and warns of any breaches or incompatibilities, and offers options for resolution.

Based on the nature of the information flowing in the eBP, the characteristics of the Internet-based business model, the operating environment and external forces, the DCT Methodology defines a first-order governing Trust Standard (TS) that may subsequently be refined. This TS sets the overall DCT design integrity requirements.

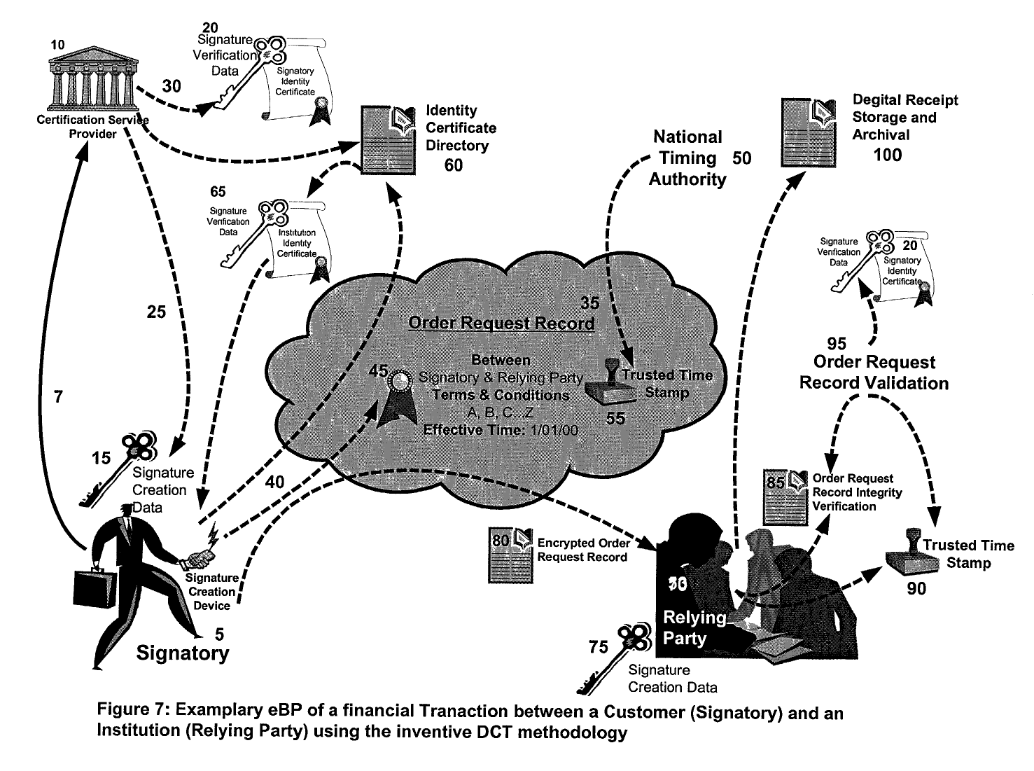

FIG. 7 shows an eBP having a financial transaction between a customer (signatory) and an institution (relying party), and is by way of an example of the applicability of the DCT to a generic, yet illustrative business example involving the execution of end-to-end electronic agreement. Note that even within this example, the inventive DCT architecture may vary, depending on the selection of many of the external variables that determine the level of risk mitigation to be implemented.

The following is a step-by-step description of the process and logic involved in implementing the DCTM in order to design an electronic process architecture that will have business integrity, security, compliance and enforceability.

Step 1: Define Business Application:

The electronic execution of a high value financial transaction between a Signatory (business customer) and a Relying Party (Financial Institution) involving competitively sensitive business information related to time sensitive and volatile commodity stocks.

Step 2: Define the Business Environment:

The agreement is to be executed over the open Internet between the Institution and the Signatory.

Step 3: Define the Business Functional Requirements

The Signatory and the Institution must have Identity Certificates issued by a trusted Certification Service Provider. They must involve a physical identity vetting process to ensure strong authentication. A transaction record (Order Request Record) must be created by the Signatory, electronically signed, time stamped using a auditable record traceable to legally recognized time and sent to the Institution using strong encryption. The institution must decrypt the transmission; verify the integrity of the Signatory's identity, the integrity of the transaction request, and the integrity of the time of order. If all is verified positive, the Institution will process the transaction, create a digital receipt and archive the entire end-to-end transaction history for regulatory compliance and possible dispute resolution and transaction enforceability.

Step 4: Identify External Factors:

There are laws governing the validity and enforceability of electronic contracts with consumers and personal information privacy laws governing the collection use and disclosure of personal information. Financial regulations require a complete electronic audit record of the transaction to be generated and archived for seven years.

Step 5: Company Risk Sensitivity: High:

The degree of sensitivity and confidentiality in this transaction is considered high. There is a requirement for strong identity authentication of both the customer and the institution and, high integrity of transaction information, requirement for verification of the integrity of the order and electronic signatures, the time of the order request and the time the transaction was executed by the institution, confidentiality during transmission, and compliance to financial privacy laws.

Step 6: Construct a trustworthy electronic transaction Architecture using the Digital Chain of Trust methodology

Step 6a: Define the DCT Chain Specifications:

1. Signatory must subscribe for an Identity Certificate for the purpose of strong Identity Authentication

2. An electronic Order Request Record must be created and signed electronically by the Signatory

3. The Order Request Record must be time stamped using a auditable source traceable to legally recognized time

4. The Signatory must obtain and verify the Identity Certificate of the Institution

5. The Order Request Record must be sent to the verified Institution

6. The Order Request Record must be sent using strong encryption

7. The institution must decrypt the transmission

8. The Institution must verify the integrity of the Signatory's

9. The Institution must verify the integrity of the transaction

10. The Institution must verify the integrity of the time of order

11. If all is verified positive, the Institution will process the transaction

12. The Institution must create a digital receipt of the transaction

13. The Institution must archive the entire end-to-end transaction history f of the transaction

Step 6b: Identify the Trust Segments, Trust Elements, Trust Components and Trust Elements required to deliver the specifications. Elements of FIG. 7 will be references according to the following numbering system (#). Figures illustrating the corresponding DCT will be made by reference Figure #.#.# and underlined for purposes of distinction.

1. Signatory must subscribe for an Identity Certificate for the purpose of strong Identity Authentication

a. The Signatory (5) subscribes (7) for an Identity Certificate (20) from a trustworthy Certification Service Provider (10) (FIG. 1.2, and further detailed by FIG. 1.2.1: Trust Element 1.2.1.1)

b. The Signatory (5) completes the high Trust Level Identity Vetting Process based on Physical Vetting (FIG. 1.1, and further detailed by FIG. 1.1.1: Trust Function 1.1.1.1) as necessary by the business requirement of strong authentication

c. The Certification Service Provider (10) generates the Signature Verification Data (SVD) (20) and the Signature Creation Data (SCD) (15) (FIG. 1.1, and further detailed by FIG. 1.1.2: Trust Component 1.1.2) and binds the SVD (FIG. 1.1, and further detailed by FIG. 1.1.3: Trust Element 1.1.3.1) to the Signatory's Identity Certificate (20) resulting from the Trust Function 1.1.1.1 (b above), and delivers directly it (securely and confidentiality) the SCD to the Signatory (FIG. 1.1, and further detailed by FIG. 1.1.3: Trust Element 1.1.3.2). The Signatory's Identity Certificate (20) is issued (30) according to the required level of trust (i.e Trust Requirement).

2. An electronic Order Request Record must be created and signed electronically by the Signatory

a. An Order Request Record (35) is created by the Signatory (5). The Order Request Record is processed to create a Digital Fingerprint (FIG. 2.1 and further detailed in FIG. 2.1.1: Trust Component Record Digital Fingerprint Creation) and further processed to bind the identity of the Signatory to the Order Request Record (FIG. 2.2: TBB Electronic Signature Creation), resulting in the electronically signature of Order Request Record (45).

3. The Order Request Record must be time stamped using a auditable source traceable to legally recognized time

a. The application used to generate the Order Request Record accesses a time source that has an audit trail back to the Network Synchronization time (FIG. 3, further detailed in FIG. 3.2: TBB: Time Synchronization) and also to the National Timing Authority (50) (FIG. 3, further detailed in FIG. 3.1: TBB: Legal Time Source). A verifiable Time Stamp (55) is applied to the Order Request Record (FIG. 3, further detailed in FIG. 3.3: TBB Time Stamping)

4. The Signatory must obtain the valid Identity Certificate of the Institution

a. The Signatory requests (60) the Institution's Identity Certificate, from the Certification Service Provider (10), verified for validity status and integrity, and obtains the certificate (65) (FIG. 1.2, further detailed in FIG. 1.2.1: Identity Certificate Management During Validity Period) with the Signature Verification Data.

5. The Order Request Record must be sent using strong encryption to the verified Institution

a. The Signatory encrypts the Order Request Record (35) and send it to the verified Institution (Relying Party) using encryption (FIG. 5.1, TBB: Transmission and Reception of Electronic Record). The Signatory is assured confidentiality and that only the Institution (Relying Party (70)) will be able to receive and process the transaction.

6. The institution must decrypt the transmission

a. The Institution (70) receives the encrypted Order Request Record (80) and decrypts it using the Signature Creation Data (75) corresponding to the Signature Verification Data bound to the Institution's Identity Certificate (60) (FIG. 5.1.3: TC: Access Control).

7. The Institution (Relying Party) must verify the identity of the Signatory's and the integrity of the Order Request Record—Order Request Validation (95)

a. The Institution (Relying Party) verifies the validity and integrity of the Signatory's Identity and the integrity of the Order Request Record by conducting an verification of the Signatory's Electronic Signature (45) (FIG. 2.3: TBB: Electronic Signature Verification) (85)

b. In order to perform the verification of the Signatory's Electronic Signature, the Institution must obtain the Signatory's Identity Certificate (20) from the Certification Service Provider (10) and verify its validly and integrity at the time of signature (FIG. 1.3: Identity Certificate Verification) (see next step).

8. The Institution must verify the integrity of the time of order

a. The time of signature is determined by the verification of the time stamp contained in the Order Request Record (90). The time stamp is an electronically signed record and therefore the process of verification is equivalent to that of an electronically signed record (FIG. 2.3: TBB: Electronic Signature Verification

9. If all is verified positive, the Institution will process the transaction. All proves to have integrity. The Institution proceeds with executing the transaction.

10. The Institution must create a digital receipt of the transaction and archive the record.

a. The transaction has been executed and the Institution must generate the electronic forensic evidence (Digital Receipt (100) of the transaction, who was involved, what was involved, when all the electronic events occurred and how the sequence of events transpired (FIG. 4.0: Trusted Digital Receipt)

Industrial Applicability

An example of the applicability to commerce of the inventive method is in the insurance industry, whereby rates would be set or adjusted after audit and analysis of the DCT of a given client, pinpointing the areas of vulnerability to various liabilities. After relevant re-engineering of the operational DCT, a subsequent audit would yield rate adjustments reflecting higher mitigation of risk.

It should be understood that various modifications within the scope of this invention can be made by one of ordinary skill in the art without departing from the spirit thereof. For example, while the risk categories identified here are typical risks, it should be understood that other risks may be identified, or may arise in the future, or that re-sorting risks into other, differently named or identified categories can be made within the spirit and scope of the invention. Likewise other categories can be differently identified, or other elements, blocks, components and segments can be grouped differently, alone or in combination with new such elements, blocks, components and segments, yet such grouping and naming is within the scope of this invention. We therefore wish this invention to be defined by the scope of the appended claims as broadly as the prior art will permit, and in view of the specification if need be, including equivalents thereof.

1. Method of design of a verifiably secure, authenticatable, and legally enforceable e-business process comprising the steps of:
a) analyzing the chain of events occurring in said e-business process to identify a sequence of event chain steps;
b) evaluating each step of said event chain for nature and level of risk in each of the following risk categories:
i) identity risk (who);
ii) information integrity risk (what);
iii) time-of-event risk (when);
iv) enforceability risk (how);
v) confidentiality risk (access); and
vi) personal information privacy risk;
c) mapping, for each evaluated risk level in each category, a risk mitigation segment architecture;
d) selecting, for each segment, at least one risk mitigation technique sufficient to provide a preselected level of risk reduction, generate a digital receipt that is independently verifiable by a trusted third party as to time, sequence and nature of said events, and provide information about said events and said architecture itself that has verifiable integrity for legal enforceability as a verifiable digital chain of trust for said e-business process.

2. Method as in claim 1 wherein said segments are:
a) Trusted Identity Authentication (who);
b) Trusted Information Integrity (what);
c) Trusted Time (when);
d) Trusted Digital Receipt (how);
e) Trusted Access; and
f) Personal Information Privacy.

3. Method as in claim 2 wherein said Trusted Information Integrity segment comprises building blocks of:
a) Identity Registration;
b) Identity certification Life Cycle;
c) Identity Certificate Verification; and
d) Signature Creation Data Life Cycle.

4. Method as in claim 2 wherein said Trusted Information Integrity segment comprises building blocks of:
a) Digital Fingerprint;
b) Electronic Signature Creation; and
c) Electronic Signature Verification.

5. Method as in claim 2 wherein said Trusted Time segment comprises building blocks of:
a) Legal Time Source;
b) Time Synchronization; and
c) Time Stamping.

6. Method as in claim 2 wherein said Trusted Digital Receipt segment comprises building blocks of
a) Identity Electronic Forensic Evidence;
b) Record Electronic Forensic Evidence;
c) Time Electronic Forensic Evidence;
d) Digital Receipt Electronic Forensic Evidence;
e) Digital Receipt Storage and Archival; and
f) Digital Receipt Retrieval and Verification.

7. Method as in claim 2 wherein said Trusted Access segment comprises building blocks of
a) Transmission and Receipt of Electronic Record;
b) Storage of Electronic Record;
c) Archival of Electronic record; and
d) Retrieval and Verification of Electronic Record.

8. Method as in claim 2 wherein said Personal Information Privacy segment is comprised of building blocks of:
a) Notice and Consent of Data Subject
b) Access and Openness;
c) Safeguard of Record;
d) Retention and Destruction of Record; and
e) Complaint and Redress.

9. Method as in claim 2 wherein said segments comprise a plurality of components having elements.

10. An Internet business method for delivery of digital trust services for e-commerce to users of e-business processes comprising:
a) establishing a website having secure web pages assignable to individual users; and
b) providing via said pages at least one of consultation, communication, services, information, education and links relating to:
i) analysis of the chain of events occurring in said e-business process to identify a sequence of event chain steps;
ii) evaluation of at least one step of said event chain for at least one of nature and level of risk in each of the following risk categories:
a. identity risk;
b. information integrity risk;
c. time-of-event risk;
d. enforceability risk;
e. confidentiality risk;
f. privacy risk;
iii) mapping, for each evaluated risk level in each category, a risk mitigation segment architecture; and
iv) selection, for at least one selected segment, risk mitigation techniques sufficient to provide a preselected level of risk reduction, generate a digital receipt that is independently verifiable by a trusted third party as to time, sequence and nature of said events, and provide information about said events and said architecture itself that has verifiable integrity for legal enforceability as a verifiable digital chain of trust for said e-business process.
